(19) United States
(12) Patent Application Publication
(10) Pub. No.: US 2006/0031174 A1
(43) Pub. Date: Feb. 9, 2006

(54) Method of authentication and indentification for computerized and networked systems

(75) Inventor: Moshe Steinmetz, Port Washington, NY (US)

Correspondence Address: DAVIDSON, DAVIDSON & KAPPEL, LLC, 485 SEVENTH AVENUE, 14TH FLOOR, NEW YORK, NY, 10018, US

(73) Assignee: Scribocel, Inc., Port Washington, NY (US)

(21) Appl. No.: 11/148,619

(22) Filed: Jun. 9, 2005

Related U.S. Application Data
(60) Provisional application No. 60/589,534, filed on Jul. 20, 2004.
(60) Provisional application No. 60/656,427, filed on Feb. 24, 2005.

(51) Int. Cl. H04L 9/00

(52) U.S. Cl. 705/67; 705/75

(57) ABSTRACT

The invention consists of a uniquely punched or printed key, often in the form of a card, that is used to identify and authenticate a user during online transactions. The computer randomly generates an array of characters, such as numbers, letters or symbols, which is displayed to the user, e.g., on a computer monitor, or printed, such as in matrix format. When held over the displayed matrix, the key allows the user to view only certain portions of the matrix, which portions together form the user's one-time-password, which is unique for each authentication transaction. The user is then authenticated by utilizing both the actual key and a password or personal identification number. This two-pronged requirement for authentication insures the high security level provided by the system.

### FIELD OF THE INVENTION

The present invention relates generally to authentication systems and more specifically, to a method of authentication that maximizes Internet security for both the corporate industry and the business to consumer market.

### BACKGROUND OF THE INVENTION

Authentication is the process of reliably verifying the identity of an individual who is attempting to access a network. Authentication determines a user's identity, as well as the information that the user is authorized to access, such as a financial database or a support knowledge base, etc.

Most people pass through authentication processes while barely noticing them. For example, an individual who calls a bank to inquire about his/her balance is asked by the bank representative over the phone to provide personal identification information, such as the last four digits of his/her social security number, phone number, birth date, address, etc. Upon hearing the correct response, the bank representative is able to authenticate the caller by assuming that, if the caller knows the answers to the questions, the caller must, in fact, be authorized to inquire about the account.

Another example occurs when a person shopping in a store chooses to pay by credit card. In order to complete the payment transaction, the customer is required to show the actual credit card as well as to provide a signature. The cashier then authenticates the transaction by assuming that, if the customer possesses the credit card and the customer's signature is identical to the signature on the card, then the customer must, in fact, be the authorized user of the card. Occasionally, the cashier may ask for additional identification, such as a driver's license.

A third example is when a user attempts to withdraw money from a bank Automated Teller Machine (ATM). The customer must first insert a bank card or credit card and then provide a PIN code in order to begin the transaction.

The problem of personal identification has become extremely crucial as use of the Internet has grown and become a standard part of our lives. Millions of people throughout the world can sit behind computer screens anywhere and perform billions of online transactions (Internet shopping, bill payments, online banking, accessing highly protected networks, and more), thus creating an enormous potential risk for fraud. Unfortunately, the Internet has also allowed anyone to hide his/her true identity and pretend to be someone else. As a result, identity theft has become one of the biggest problems society must cope with in the Internet era.

Many business to consumer based organizations, such as banks, credit card companies, governments, merchants, service providers and more, have opened their services to the general public via the Internet. However, these organizations need to protect their businesses from identity hijackers, hackers, defrauders, masqueraders and other criminals who find the Internet a comfortable place to commit their crimes. Organizations like these are losing tremendous amounts of money and time because of these threats, while spending huge amounts of money and time to develop and maintain authentication and security systems.

Furthermore, as the Internet has become increasingly accessible to individuals in various settings (at homes, in hotels or at airports), many corporations and enterprises have opened their protected networks to the Internet, to enable employees to access internal networks as needed. This increases productivity and efficiency, as people can now work from home or telecommute, and road warriors like salespeople and support staff can access the network at any time and from any place. However, security remains a chief concern.

From the perspective of network security, authentication is the most difficult challenge to overcome. There are three major ways through which authentication may take place on the Internet and networked systems:
knowledge, wherein the user knows or remembers a password or personal identification number (PIN) that the user uses to authenticate a transaction;
ownership, wherein the user owns a device, such as a software-based key that has unique and encrypted information (e.g., a digital certificate), a one-time password token, a challenge-response list or a Smart Card, that is used to authenticate a transaction; and
biometrics, wherein a physical feature of the user, such as a fingerprint, retina or voice pattern, etc., is measured and recognized by the computer for authentication purposes.

The most common form of authentication is a user name and password, although it is the least secure form of authentication and consists of only one of the above-mentioned mechanisms (i.e., knowledge). It is considered good practice to combine at least two of the three major authentication systems, since each authentication system, by itself, may be easily compromised. For example, a user-owned device is susceptible to ordinary theft, while passwords or PIN's known to the user may be compromised by Internet or “over the shoulder” sniffing. As a result, most presently-used systems combine these approaches. For example, a Smart Card, which requires the user to enter a PIN, is a combination of an “ownership” device (i.e., the Smart Card itself) and a “knowledge” device (i.e., the PIN). Similarly, ATM's use a combination of two of the above-mentioned systems (i.e., a card and a PIN).

Many authentication tools and methods, both hardware and software based, have been developed in order to address the need for strong authentication in the B2C and other markets. Some of the currently available hardware tools are: credit and debit card readers (devices that connect to a computer and allow the user to “swipe” his/her card), smart cards and their reader devices, biometric devices such as fingerprint readers, retina scanners and voice recognition devices, and USB tokens. While these tools and methods provide reliable authentication, they have many disadvantages, among which are that the hardware tools all require a device or card reader to be physically connected to a computer, that their costs of production and maintenance are very high (˜$50-$100 per unit), that they are disposable, that they are impossible to deploy to the masses, and that they are difficult to install and cumbersome to use.

Software authentication tools, such as Digital Certificates, are also available. However, they too are costly, difficult to deploy and maintain, and are not at all portable.

Because of the stated difficulties, the above solutions have generally failed, and, due to lack of a better alternative, the B2C market has adopted the most common, yet the least secure, method of authentication—the Password method.

The corporate and enterprise industry is different from the business to consumer market. Unlike the business to consumer market, corporations and other enterprises have more control over their organizations and their users. A corporation consisting of tens, or even thousands, of users can dictate and deploy the authentication method to be used by its employees or contractors.

As a result, many hardware-based authentication tools and tokens have been developed for this market. Most of these applications are electronic token devices that maintain a synchronization algorithm with the authentication server. In most cases, the user must physically retain the hard token. Additional hardware tools and tokens, such as those mentioned above, and software-based applications are also used in the corporate market.

FIG. 1 shows examples of authentication devices that are currently being used, including RSA SecureID (FIG. 1A), Vasco Digipass (FIG. 1B), and Activecard smart card and card reader (FIG. 1C), which are used in the corporate market. Some of these applications provide the advantages of strong authentication and portability. However, their disadvantages include that their costs of production, deployment and maintenance are very high, that they are disposable after two to three years, that they are breakable, that they are based on disposable batteries, that they are susceptible to frequent malfunctions, that they are likely to be lost and/or broken, and that they are thick and bulky and thus difficult to carry. Furthermore, these tokens cannot be used in the business to consumer market because they are not designed to be deployed to the public at large.

Like the B2C market, many enterprises have also adopted the most common, yet the least secure, password method because of the difficulties in deploying hardware token-based authentication systems, such as those shown in FIG. 1.

A number of methods and devices have been proposed to overcome the difficulties discussed by using matrices or cards to help the user remember or derive his pass code or PIN. For example, in U.S. Pat. No. 5,246,375 to Goede, a transparent card aids a user to remember a PIN with a matrix of numbers disposed thereon. The user memorizes an (x,y) location on the matrix at which a recording sheet is registered, and when the recorded sheet member is disposed under the substrate at the user defined location, the personal identification number is shown.

U.S. Pat. No. 5,251,259 to Mosley discusses a system for varying a password or PIN, wherein a group of seven PIN's are assigned to each card holder for use in a specific sequence changing each calendar day. A 7×7 grid of randomly selected numbers and letters allows the user to access seven three-digit codes that must be used in the correct sequence, as determined by the number of uses per calendar day. If a PIN is used out of sequence, then access to the charge or credit card is denied.

U.S. Pat. No. 5,742,035 to Kohut discloses a device for aiding a user to recall a PIN in the form of a label containing a geometric matrix that is applied to the surface of a bank or credit card. A sequential pattern is chosen within the matrix, and the PIN is installed into the sequential pattern in a predetermined order, with the remaining spaces within the matrix being filled-in with other numbers or characters. By recognizing a single sequential pattern within the matrix, the authorized user can recall a PIN for any card bearing such a matrix label, without jeopardizing the intended security associated with PIN use.

While these devices help a user to remember a PIN or pass code, or to derive a preset PIN or pass code, they do not involve the physical use of any card to derive a dynamic password or to authenticate a transaction. Other systems use the card to authenticate a transaction.

For example, U.S. Pat. No. 4,016,404 to Appleton discusses a method of verifying a credit card use, wherein a matrix of holes formed in a predetermined order through the credit card stores information. A processing unit, pre-programmed to determine the matrix bit positions and the sequence of a user code from the information matrix as a function of the numerical value of a scrambler code, reads the information matrix from the credit card and, by comparison of the encoded information with a code manually entered by a user, determines whether the credit card use is authorized. Unfortunately, however, this system is useful for authenticating credit cards used during point of sale transactions only, and is not usable for remote transactions, such as over the Internet.

In U.S. Pat. No. 5,488,664 to Shamir, a method for protecting visual information against unauthorized access and modification using a printed cryptographic watermark is discussed. A first array of shapes is printed on a first sheet of material to be protected, and a second array of different shapes is printed on a transparent medium to form a developer. When the transparent developer is placed over the first sheet, a watermark, which is not visible in either of the sheets alone, is encoded. The watermark is encoded by preparing each array using black and white pixels that have been split into a first collection of sub-pixels that appears in the first array and a second collection of sub-pixels that appears in the second array. When the two printed sheets are placed directly over each other, the first sheet of material can be seen through the second, transparent sheet, making the watermark (the combined image) visible.

In “Visual Cryptography”, by Moni Naor and Adi Shamir, Advances in Cryptology—Eurocrypt '94 Proceeding, Workshop on the Theory and Application of Cryptographic Techniques, Perugia, Italy, May 1994, Lecture Notes in Computer Science, Vol. 950, Springer-Verlag, 1995, pages 1-12, a secure cryptographic scheme that can decode concealed images without any cryptographic computations is disclosed.

In “Visual Cryptography II: Improving the Contrast Via the Cover Base”, by Moni Naor and Adi Shamir, Security Protocols, International Workshop, Cambridge, United Kingdom, April 1996, Lecture Notes in Computer Science, Vol. 1189, Springer-Verlag, 1997, pages 197-202, an alternative model that enables the achievement of a better contrast than in the previously discussed scheme is proposed.

In “Visual Authentication and Identification”, by Moni Naor and Benny Pinkas, Advances in Cryptology—Crypto '97 Proceedings, 17th Annual International Cryptology Conference, Santa Barbara, USA, California, August 1997, Lecture Notes in Computer Science, Vol. 1294, Springer-Verlag, 1997, pages 322-36, the authors discuss various authentication and identification methods for human users using visual cryptography. The methods are easy to use and implement using “low tech” technology.

In U.S. Pat. No. 6,728,376 to Dean et al., a system for encrypting documents with stencils is discussed, providing a way to decrypt original image content in two passes. An encrypted image is partially recorded through a stencil to a first recording medium, and then the image is partially recorded through a complement of the stencil to a second recording medium. The two mediums are then stacked together to fully decrypt the original image content.

U.S. Pat. No. 6,095,566 to Yamamoto, et al. discusses an image recording system used to superimpose additional information. The superimposed image is used for certification, and this method is used as a personal identification product to prevent falsification and forgery of identification cards. An image recording system superimposes on an original image an additional image that is the same as any one of visible characters, symbols or numerals on a recorded product and records the superimposed image on the recorded product as an image for certification. The additional image superimposed on the recorded product cannot visually be recognized and is visible only through a universal optical filter.

U.S. Patent Application Publication No. 2003/0070078 A1 to Nosrati et al. discusses a method and apparatus for adding security to online transactions using ordinary credit cards. This method increases the level of security over the regular use of ordinary credit and debit cards. However, the user is required to carry an electronic identification device in order to be authenticated by the financial institution.

International Patent Application Publication No. WO 02/065411 A2 to Benedetti discusses a method and system for making a commercial transaction secure with the use of a smart card. The proposed method uses the following steps: a user enters identification data and a PIN code, a third party server (which authorizes the transaction for the merchant site) sends to the user at least two variables defining an authentication key in a matrix printed on a material medium available to the user, the user then transmits to the third party server the authentication key using the input variables received from the server, and the server finally verifies the authentication key transmitted by the client if it corresponds to the key defined by the authentication table stored in the third party server database.

Others devices enable the use of temporary, or dynamic, codes that are valid only for the specific transaction in progress. In U.S. Pat. No. 6,246,769 to Kohut, a temporary code is randomly selected by the system and displayed to the user encoded within a completely filled geometric matrix along with other non-code characters. The user must recall a single, predetermined sequential pattern within the matrix in order to obtain the access code. If the entered access code matches the transaction specific code in system memory, access to the protected resource is granted and the transaction is allowed to proceed.

Temporary codes are also used in the Matrix-Card, shown in FIG. 1D, which is currently used by VP Bank of Liechtenstein to authenticate its Internet banking users. The user possesses a matrix card that contains a number of preset 4-digit alpha-numeric codes, e.g., 64 or 128 codes, arranged in rows and columns, and at each e-banking login the system identifies, by row and column, the location on the matrix card of a specific code that the user must enter. The system stores in memory the various codes and, upon the user's entry of the correct code from within matrix, authenticates the user for the transaction.

In addition, temporary codes are used with IdentityGuard, by Entrust of Addison, Tex., shown in FIG. 1E. In this system, users are provided with a card on which an assortment of characters is printed in row/column format. At each login, the system identifies, by row and column, several locations on the matrix card, and the user must successfully enter the correct characters at the identified locations in order to demonstrate that he is in possession of the appropriate card. The system stores in memory the various codes and, upon the user's entry of the correct characters from within matrix, authenticates the user for the transaction.

International Application Publication No. WO 02/17556 A1, to CMX Technologies PTY Ltd., of Australia, discloses a system known commercially as NextID, which is a system and method of validation for transactions between a user terminal and a server using a card (called a key) that allows a user to correlate the position of a point on a visual display or on the key with the position of a second point on the same display by holding the card key against the display. In a commercial embodiment, as shown in FIG. 1F, the user is provided with a PIN code and a key, on which a series of elements is printed, with a view through window next to each element. In order to validate a transaction, the server challenges the user with a displayed elements, and the user must hold the key against the displayed elements and, using the PIN as an index locator on the displayed elements, match every element in the displayed elements to the elements on the key, and enter the correspondents elements from the key.

U.S. Pat. No. 6,406,062 to Brooks discloses a hidden image game piece and a method by which a hidden image game piece is produced and used (although not for authentication purposes). A first hidden image game piece is formed on a transparent or translucent substrate, and a second hidden image game piece is formed electronically, and optionally printed or, alternatively, saved and distributed in electronic format. The hidden image game piece, using color filtering techniques, can be used to derive demographic information from recipients, to drive them to web sites or retail outlets, and to provide a means for distributing advertising.

### SUMMARY OF THE INVENTION

Accordingly, it is one object of the present invention to provide a new and improved authentication system that maximizes Internet and network security.

It is another object of the present invention to provide a new and improved authentication system that is generic and applicable to all industries.

It is a further object of the present invention to provide a new and improved authentication that is user friendly, inexpensive to produce and maintain, portable, free of complicated, electronic hardware devices, and easily deployed to the general public.

It is still another object of the present invention to provide a new and improved authentication system that requires the user to both physically possess and use an article, as well as to remember a password or personal identification number (PIN), thereby maximizing the level of security for online transactions.

It is still a further object of the present invention to provide a new and improved authentication system that requires the user to enter a completely new and randomly different password for each transaction

In accordance with these and other objects of the invention, the present invention is preferably comprised of the following physical components: a key card and a network access device. The invention is preferably also characterized by a key-sequence, a matrix, an algorithm, a one-time password and a challenge response.

The network access device can be any known communications device, e.g., computer, PDA, cell phone, ATM, etc., that preferably can be used to perform online transactions. The network access device enables connections to the server for the authentication procedure and preferably also comprises a monitor or screen for displaying information to the user.

A uniquely hole-punched or printed key, generally in the form of a card, is preferably used to authenticate and identify a cardholder when used in online transactions. The card can preferably be made of any material, e.g., typically plastic, and is preferably in the size and shape of a credit card, although it may also be made of other materials and/or be sized or shaped differently. The card may be associated with a user account, whereby it contains each user's unique credentials (e.g., username and password/PIN) by any standard mechanism, e.g., a magnetic strip, or it may be used without user credentials. In a preferred embodiment of the invention, when held over a series of numbers, symbols or characters that are displayed or printed in a specific format, layout or array, generically called a matrix, such as by being held against the monitor on which is displayed (or printout on which is printed) the displayed matrix, so as to cover at least portions of the matrix, the card reveals a dynamic, one-time password (OTP) that is unique for each authentication transaction.

Every card is uniquely identified by a sequence of randomly generated numbers or characters called a key-sequence. The key-sequence is represented as a series of two-dimensional cell locations (i.e., vectors) formed on or through the surface of the card. The length of the key-sequence may vary in accordance with the optimal tradeoff between user friendliness and the required strength of security. The key-sequence determines which portions of the matrix are used to reveal the one-time password for that transaction.

A matrix, layout or array is a series of data (numerical or character), represented in two-dimensional format, such as by rows and columns, which together create cells representing specific values. In the present invention, the preferred way to derive the unique, one-time passwords that users enter in order to authenticate online transactions is through the use of the array of data, herein generically termed “matrix”. The server of the network access device uses an algorithm to present a scrambled and randomly-generated matrix to the user on the monitor or other display or printout in a predetermined format or orientation. Many types of algorithms may be utilized with the present invention, although the algorithms detailed herein are based on matrices and key-sequences.

An OTP is derived from a randomly generated matrix sent by the server and displayed on the user's monitor. The user derives the OTP by holding the card against the matrix that is displayed on the monitor, or covering the matrix wherever it is displayed or printed, such that only certain portions of the matrix are revealed, based upon the card's unique key-sequence. The revealed portions of the matrix form the OTP, which the user enters into the computer (or other device) in order to authenticate the transaction. Preferably, because the matrix is randomly generated and is not stored, but rather only is displayed to the user, the OTP is different for each online transaction.

In a typical Challenge-Response sequence, the server challenges the user and the user responds. The user provides his/her user name and password and, after the server successfully verifies the user name and password, the server challenges the user by displaying a scrambled and preferably randomly generated matrix. The user responds by covering the displayed matrix with his/her key card and typing in the OTP. The system verifies whether the entered OTP is correct. If the OTP entered is correct, the transaction is authenticated.

### BRIEF DESCRIPTION OF THE DRAWINGS

The above and other objects and advantages of the invention will be apparent upon consideration of the following detailed description, taken in conjunction with the accompanying drawings, in which the reference characters refer to like parts throughout and in which:

FIG. 1 shows examples of prior art hardware-based and card-based authentication devices that are currently being used;

FIG. 2 shows an embodiment of the hardware system for operation of the present invention;

FIG. 3 shows a typical flow of an online transaction;

FIG. 4 shows one example of a matrix that may be used in the present invention;

FIG. 5 shows the matrix of FIG. 4 in scrambled form;

FIG. 6 shows a first embodiment of the card as used in the present invention;

FIG. 7 shows a second embodiment of the card as used in the present invention;

FIG. 8 shows a first example of a randomly generated result for an eight vector key-sequence, using a matrix of 50 cells;

FIG. 9 shows a second example of a randomly generated result for a different, eight vector key-sequence, using a matrix of 50 cells;

FIG. 10 shows an example of an unscrambled matrix and its use in conjunction with the card of FIG. 6 to derive an OTP;

FIG. 11 shows an example of a scrambled matrix and its use in conjunction with the card of FIG. 6 to derive an OTP;

FIG. 12 shows an example of a computer screen before the user introduces the card in an online transaction;

FIG. 13 shows an example of a computer screen after the user introduces the card in an online transaction;

FIG. 14 shows a side-by-side comparison of the cells of a 5×10 matrix before and after scrambling;

FIG. 15 shows an example of how the server matches the user-entered OTP with the key-sequence stored in its database;

FIG. 16 shows examples of unscrambled and scrambled, mixed matrices;

FIG. 17 shows a basic matrix and its corresponding card key-sequence;

FIG. 18 shows two alternative layouts of a basic matrix;

FIGS. 19A and 19B shows a two embodiments of a twisted matrix and their corresponding card key-sequences;

FIG. 20 shows two further embodiments of twisted matrices;

FIG. 21 shows a key-sequence and the number of combinations for N=50, K=8;

FIG. 22 shows a key-sequence and the number of combinations for N=50, K=10;

FIG. 23 shows a key-sequence and the number of combinations for N=104, K=8;

FIG. 24 shows a key-sequence and the number of combinations for N=104, K=10;

FIG. 25 shows a card, with a key-sequence length of 12, before and after being placed over a 4×9 mixed matrix;

FIG. 26 shows an example of a card containing consecutively placed vectors;

FIG. 27 shows an illustration of simple unscrambled and scrambled matrices demonstrating order does not matter for OTP combinations;

FIG. 28 shows an example of a card that indicates its order template type;

FIG. 29 shows an example of a card that indicates the OTP entry order;

FIG. 30 shows a comparison between a 40-cell, scrambled, two-dimensional unique vector matrix and a 40-cell, scrambled, repeat-vectors matrix;

FIG. 31 shows another example of a scrambled repeat-vectors matrix;

FIG. 32 shows a card after having been placed over the 40-cell, scrambled, repeat-vectors matrix of FIG. 31 with the OTP entry order indicated on the front;

FIG. 33 shows another example of a repeat-vectors matrix that is larger than its corresponding card;

FIG. 34 shows an example of a card that indicates an OTP arithmetic operation and operand;

FIG. 35 shows another example of a card that indicates an OTP arithmetic operation and operand;

FIG. 36 shows a flowchart of a typical process for issuing a new card;

FIG. 37 shows an option for rendering the size of the matrix window according to the dot size of the monitor and/or the displayed resolution;

FIG. 38 shows an example of a re-sizeable frame;

FIG. 39 shows an option for rendering a variety of frame sizes for which the user chooses the best fit; and

FIG. 40 shows an option for leafing through different sized frames to find the best fit.

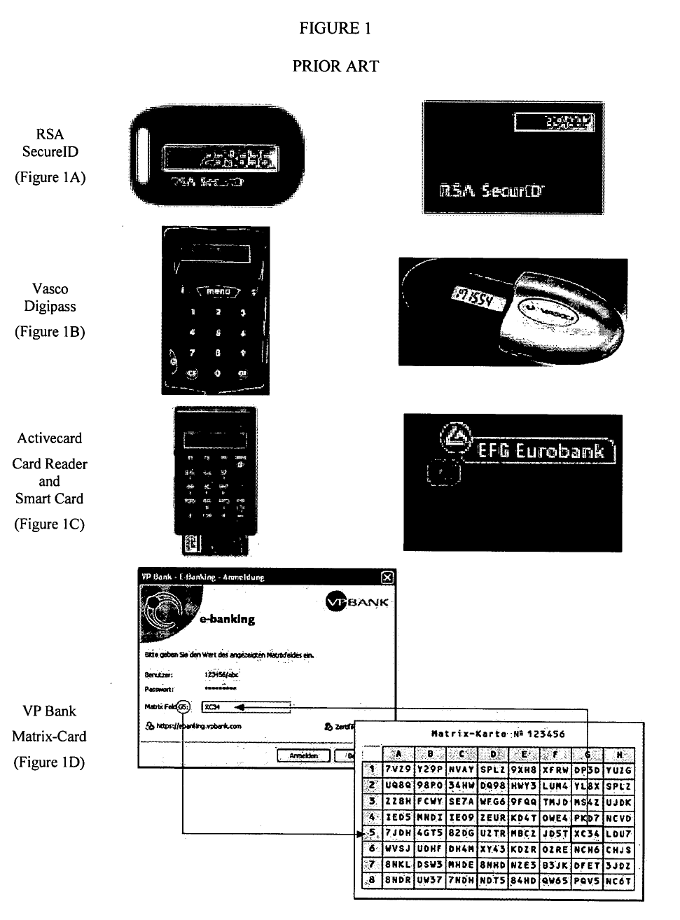

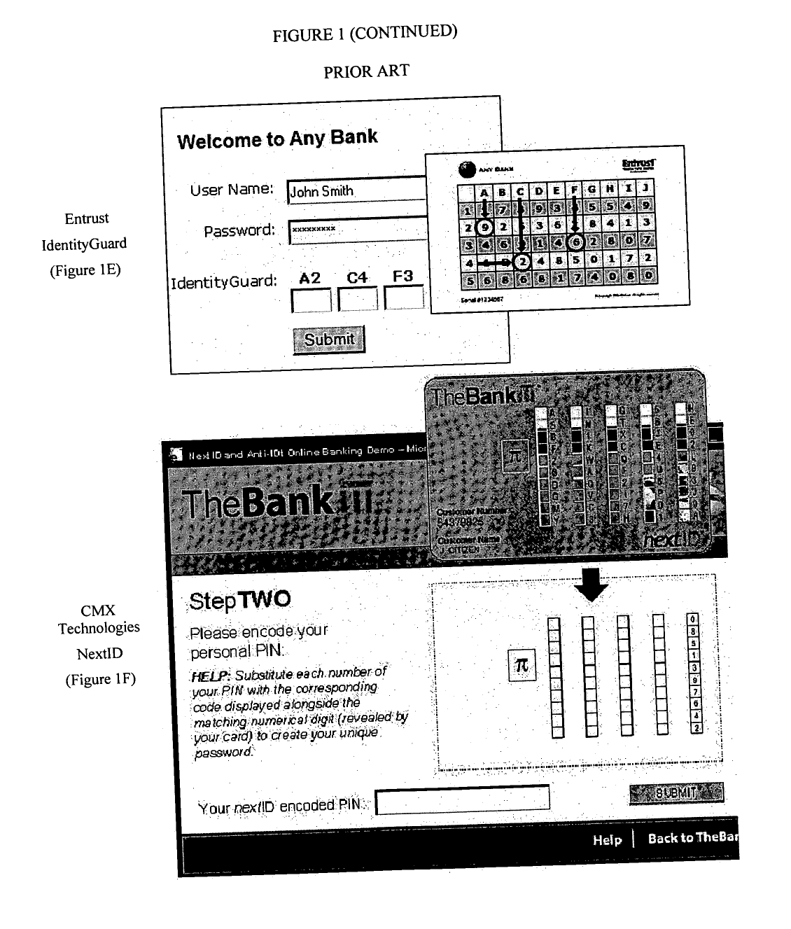

### DETAILED DESCRIPTION OF THE INVENTION

As discussed herein, the present invention provides a high level authentication system that maximizes Internet and network security during online transactions. The system is a generic solution, applicable to all industries. It is user friendly, inexpensive to produce and maintain, portable, free of complicated, electronic hardware devices, and is easily supplied to the general public. The invention can be used with any type of computer or handheld device, with any operating system, and from any location (home, office, Internet cafes, airports, etc.).

The method and system of identification and authentication of the present invention is based upon the generation of a one-time password for each transaction that the user provides to the system to which access is desired. The one-time password is provided to the user preferably through the use of a uniquely punched or printed card that is held over a randomly generated and scrambled array of characters, known as a matrix, that is displayed, such as on a monitor or printout, thereby revealing a sequence of numbers, symbols or characters that comprises the one-time password.

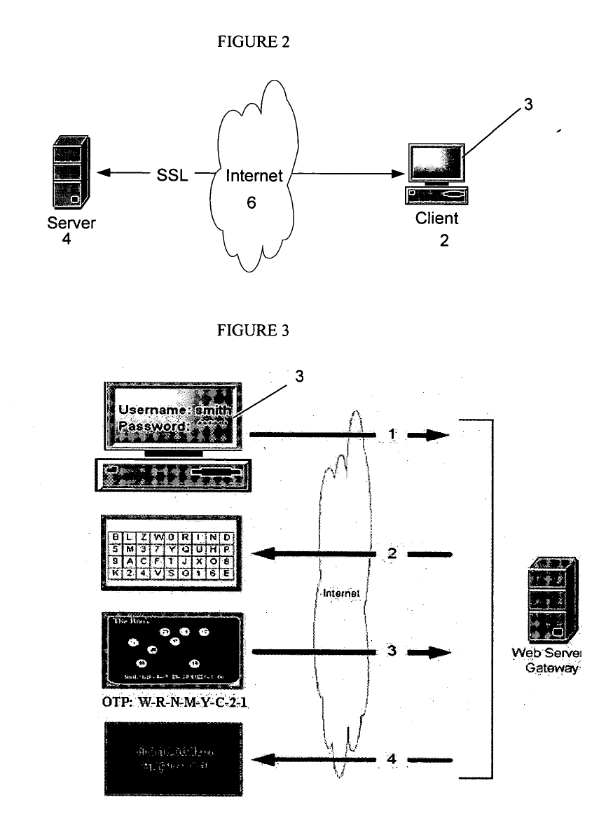

FIG. 2 shows an example of a preferred hardware system on which the present invention may be operated to perform online transactions. The system has at least a client end 2 and a server end 4, which are electronically linked for communications through an electronic network 6, such as the Internet. The server end 4 comprises the computer that runs the server end application and may include a combination of software components, such as a database, the application server, a web server and more. Usually, the server 4 is hosted in the data center of the enterprise (e.g., bank, merchant, corporate network, etc.).

The client end 2 is the application that displays a matrix, layout or array of data characters (numerical or otherwise), preferably in two-dimensional format to the user, accepts the user's inputs (such as username, password/PIN and OTP), and sends all the information to the server 4. Preferably, all communications between client end 2 and server end 4 should be encrypted, such as by using an encryption method such as SSL (Secured Sockets Layer). Depending on the application, the client end 2 might be a Browser-based application (html) or software that must be installed on the client's computer (e.g., a Virtual Private Network client, etc.). A client end network access device 3 can be any known communications device, e.g., computer, Personal Digital Assistant (PDA), cell phone, ATM, etc., using any operating system and from any location (e.g., home, office, Internet cafes, airports, etc.), that preferably can be used to perform online transactions.

The client end network access device 3 enables connections to server 4 for the authentication procedure and preferably comprises a monitor, screen or other display device, often known generically as the monitor or screen, for displaying information to the user. The client end network access device 3 can have any type of monitor, including touch screen monitors, such a those used in ATM machines or point-of-sale devices. Alternatively, the display device could utilize a printer that prints the display to the user in two-dimensional format.

FIG. 3 represents a typical flow of an online transaction in accordance with a preferred embodiment of this invention. First, depending on the implementation, the user connects to a web site/protected application or a network gateway and types in his/her username and password/PIN intro the client end network access device 3 (step 1). Then, the server validates the username and password/PIN and, if they are correct, fetches from the database the user's key-sequence (and matrix template, as discussed below, if applicable). The server then scrambles a matrix and challenges the user by displaying the scrambled matrix on the monitor or printout (step 2). Next, the user places his key card over the displayed matrix to reveal the OTP for this transaction, and enters the revealed OTP (step 3). Finally, the server verifies the OTP and, if it is correct, depending on the application, either approves the transaction, displays the protected application to the user, or logs the user in to the protected network (step 4).

As discussed more fully below, server 4 uses a specific algorithm to generate a scrambled array or matrix that is displayed on the monitor of the client end network access device 3. The matrix is preferably a series of data (such as letters, numbers, symbols or other characters, colors or shapes) that is represented in two-dimensional format. In one preferred embodiment, the matrix is comprised of rows (x) and columns (y), which together create cells (x,y), whereby each cell represents a specific value. For example, a matrix of twelve can be represented as 1×12 (one row and twelve columns), as 2×6 (two rows and six columns), as 3×4 (three rows and four columns), as 4×3 (four rows and three columns), as 6×2 (six rows and two columns) or as 12×1 (twelve rows and one column). The matrix may have alternative shapes, such as a diamond, triangle, trapezoid, etc., while still maintaining the row-column format, or not be row-column based at all, such as circular or spiral formats.

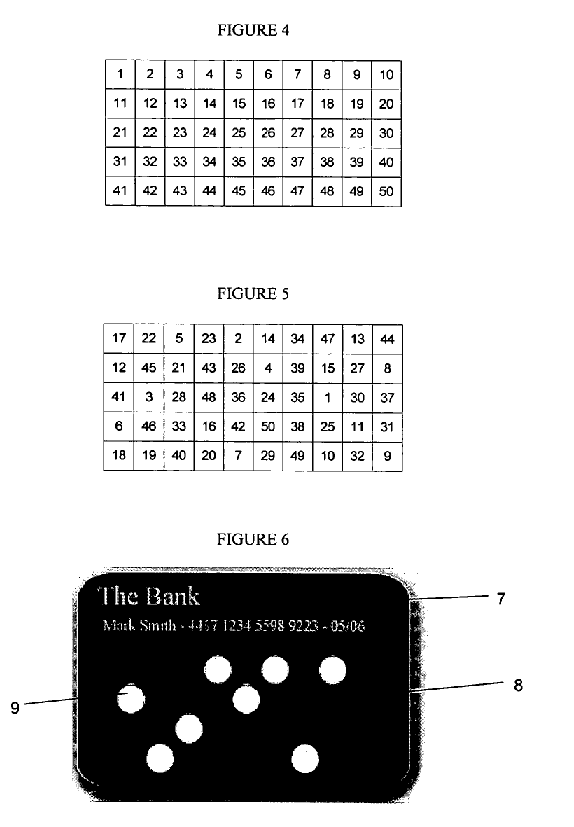

FIG. 4 shows an embodiment of an unscrambled matrix, which in this case is made up of five rows and ten columns and contains a total of 50 cells in 5×10 format, with each cell containing numbers that are consecutively numbered, preferably from left to right in each row, from the top row to the bottom row. The matrix in FIG. 4 is rectangular in shape because this is substantially the same shape as a credit card, which is familiar to most people. It should be noted, however, that, in order to vary the amount of display space on the matrix and thus have more possible characters in the OTP, matrices with different shapes, with more or fewer cells and/or with larger or smaller font sizes may be used.

When a user begins an online transaction by entering his/her username and password/PIN, the server will then display a scrambled matrix on the computer monitor, wherein every cell displayed is a different number. In accordance with the present invention, a unique, scrambled matrix will preferably be displayed on the user's screen each time a user attempts to log in to a protected site or to perform an online transaction. The server of the network access device uses an algorithm to present a scrambled and randomly-generated matrix to the user on the monitor. Many types of algorithms may be utilized with the present invention, although the algorithms detailed herein are based on matrices and key-sequences. However, any other algorithms may also be employed and utilized with the present invention.

Before displaying the matrix, the server, chooses a scrambling key from a pool of keys and, using an algorithm, scrambles the basic matrix and then displays the scrambled matrix to the user. For each transaction, the server temporarily holds the scrambled matrix in its memory, until the transaction is completed. FIG. 4 shows the matrix of FIG. 3, in this example a 5×10 matrix, in scrambled form.

The number of different combinations in which the cells of a matrix can be placed (i.e., scrambling the matrix) is represented by N! (“N factorial”), where N is the number of cells in the matrix. Thus, in a matrix of N=50, the number of combinations is: 50!=3.0414093201713378043612608166065e+64 (3 and 64 zeros to the right), meaning that, in a matrix of 50 cells, there are 3.0414093201713378043612608166065e+64 different ways in which to scramble the cells. Accordingly, for every single transaction, the chance that any specific matrix displayed will be repeated is calculated as:

$$\frac{1}{3.0414093201713378043612608166065 e + 64} ,$$

which is 3×10⁻⁶⁴ or 0.00000000000000000000000000000000000000000000000000000000000000003. While this number is not complete zero (0), it definitely approaches zero, meaning that the chance of a scrambled matrix being repeated is practically infinitesimal and statistically insignificant.

Each user of the system is issued a uniquely punched or printed key that is used as a hard token to identify and authenticate that user during online transactions, e.g., over the Internet or any other local network system, local computer or application, ATM, etc. The key can preferably be made of any appropriate material, e.g., cardboard, hard plastic (similar to a credit card) or a thin plastic film. The key should preferably be of a size and shape that will enable easy and convenient portability by the user. In a preferred embodiment, the key is in the size and rectangular shape of a credit card, although it may be sized or shaped differently to better fit computerized devices with limited display space. For example, the key may be sized and shaped differently to fit PDA's, cell phones, ATM's or other devices with monitors or LCD displays, depending upon the size of the monitor that displays the matrix. However, for simplicity, the key will hereinafter generally be referred to as a “card”.

In a preferred embodiment of the invention, the card, when held over the displayed scrambled matrix, such as when held against the monitor and over a scrambled matrix that is displayed thereon, selectively indicates or reveals specific portions of the scrambled matrix, which indicated or revealed portions comprise a dynamic, one-time password (OTP) that is unique for each authentication transaction. Accordingly, the card should have some physical indication to advise the user which portions, e.g., characters, of the matrix that lie beneath the card are to be used for the OTP.

One preferred embodiment of such a card, is depicted in front view in FIG. 6. The card 7 has selected viewing portions 9 that are formed in or through a non-viewing portion 8. The non-viewing portion 8 can be formed from any opaque material, and the selected viewing portions 9 are see-through, to allow the user to see through the opaque blocking portion 8 at only selected areas. The selected viewing portions 9 may be a series of physical holes punched through the card or may be a series of small transparent areas, e.g., “holes”, that are formed in the card, and may be circular, square or any other shape. Thus, the user is able to see through the viewing portions 9, but not the rest of the card, i.e., the non-viewing blocking portion 8, which is formed of or is covered with an opaque material.

In another preferred embodiment, the card is entirely see-through or transparent, such that the user is able to view the entire matrix through the card. However, the card possesses certain markings to indicate to the user the portions of the matrix that are to be used for the OTP. For example, the indicating portions of the card, i.e., the selected viewing portions 9, could be shaded while the non-viewing portion 8 could be non-shaded, or reverse, or the selected viewing portions 9 could have markings around them, such as circles, squares or some other shape, in order to differentiate them from the non-viewing portion 8.

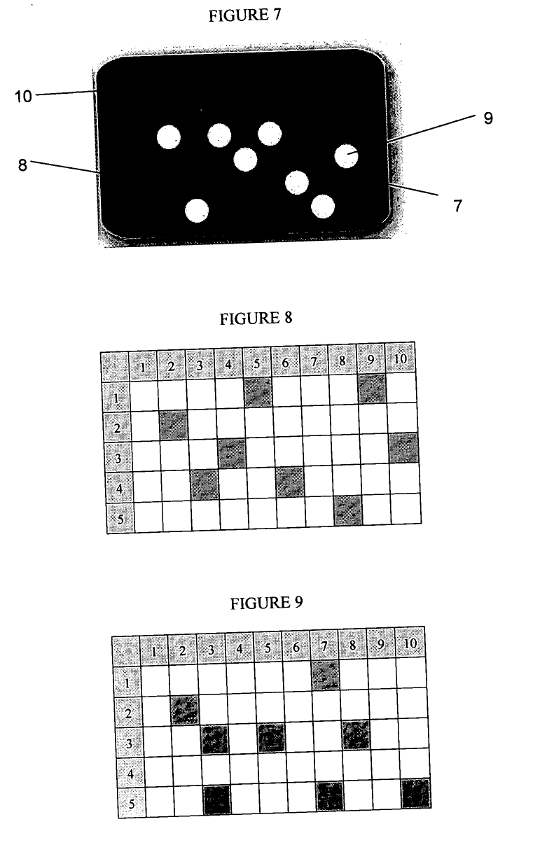

Each card that is issued may be associated with a specific user account, whereby it contains or is linked to and checks that user's unique credentials (e.g., user name and password/PIN) prior to authentication. Such a card may be used for both Internet and point-of-sale applications, and may bear additional data. Such linkage may be by any standard mechanism or technology, e.g., a magnetic strip or Smart Card chip. A preferred embodiment of such a card 7, depicted in back view and having a magnetic strip 10 in addition to holes 9 punched therethrough, is shown in FIG. 7. Alternatively, the card may be generic, i.e., unassociated with any specific user, and used as a stand-alone authentication apparatus only or for Internet-only authentication.

It is preferred that every card be uniquely identified by the server via a sequence of randomly generated letters, numbers, characters or symbols called a key-sequence, which identify specific cell locations or positions within the array, called vectors. Because each key-sequence is randomly generated, each and every card is unique. The key-sequence for each newly issued card is stored in encrypted format in the server database under the user's account and is used to derive the OTP, which the user must enter in order to authenticate an online transaction.

The key-sequence is translated into graphical form and is preferably corresponds to or is represented as a series or pattern of cell positions or locations on the card (i.e., vectors). As shown in FIG. 6, the key-sequence pattern can either be printed on the card 7 (e.g., when the card is made of thin plastic film), such as via selected viewing portions 9 that are formed in or through a non-viewing blocking portion 8, or it can be holes 9 punched through an opaque card 8 (e.g., when the card is made of plastic or other similar materials).

In FIG. 6, the pattern of holes 9 on the card preferably represents the key-sequence for that particular card, i.e., the vectors. The key-sequence determines which portions of the matrix are used to reveal the one-time password for that transaction. When the card is held against the matrix that is displayed on the computer monitor, each vector preferably reveals one number, letter, symbol or other character from within the matrix. It should be noted that, since every vector in the key-sequence represents the actual, two-dimensional (x,y) location of its corresponding cell on the matrix itself, a vector in the key-sequence cannot appear more than once (unless it is for a different type of matrix).

The length of the key-sequence may vary in accordance with the optimal tradeoff between user friendliness and the required strength of security. The strength of the key-sequence is derived from the number of cells making up the key-sequence (key-sequence length). For example, a key-sequence length of 4 vectors or cells is user friendly but is a weaker key; while a key-sequence length of 20 vectors or cells is a stronger key, but is longer and more difficult for the user to enter.

For simplicity purposes, most of the examples set forth herein will present a matrix of fifty (50) vectors and a key-sequence length of eight (8) vectors. For example, the card shown in FIG. 6 represents a typical card with a key-sequence length of eight (8) vectors, based upon the 50-cell matrix of FIGS. 4 and 5. A key-sequence with a length of eight (8) vectors might be, for instance: 4-6-8-11-15-23-42-47, which happens to be the 8-vector key sequence of the card shown in FIG. 6, as discussed below.

A key-sequence is generated by randomly choosing the desired number of vectors from the matrix of a specified size. For example, in the typical 5×10 matrix example considered herein, eight vectors, or cells, are randomly chosen from within the 5×10 matrix. Of course, more or fewer vectors may be chosen from that matrix or from a matrix of larger or smaller dimensions.

In the example shown in FIG. 8, the randomly generated result for the eight vector key-sequence is: 5-9-12-24-30-33-36-48. The direction of numbering of the cells on the matrix in this case is sequentially left to right across the rows and from top row to bottom row, from the top, leftmost cell position to the bottom, rightmost cell position. Therefore, a cell that is located under column number 9 in row number 1 will be represented as “9”, whereas a cell that is located in row number 2 under column number 2 will be represented as “12”. Similarly, in the example shown in FIG. 9, the randomly generated result for the eight vector key-sequence is: 7-12-23-25-28-43-47-50. The cells in matrices with alternate layouts can also be identified sequentially, such that a key-sequence of vectors for any matrix can be randomly generated.

A card that is produced based upon a particular key-sequence will have holes, or viewing portions 9 as discussed with respect to FIG. 6, formed in the card at the exact physical locations corresponding to the locations of the cells in the matrix that match the vectors of the particular key-sequence. As a result of the fact that the vectors in the each of the two matrices shown in FIGS. 8 and 9 are located at different locations, the holes, or viewing portions 9, formed in the actual cards produced for the key-sequences in FIGS. 8 and 9 will be located at different areas of the card, since they depend on the indicated vector locations.

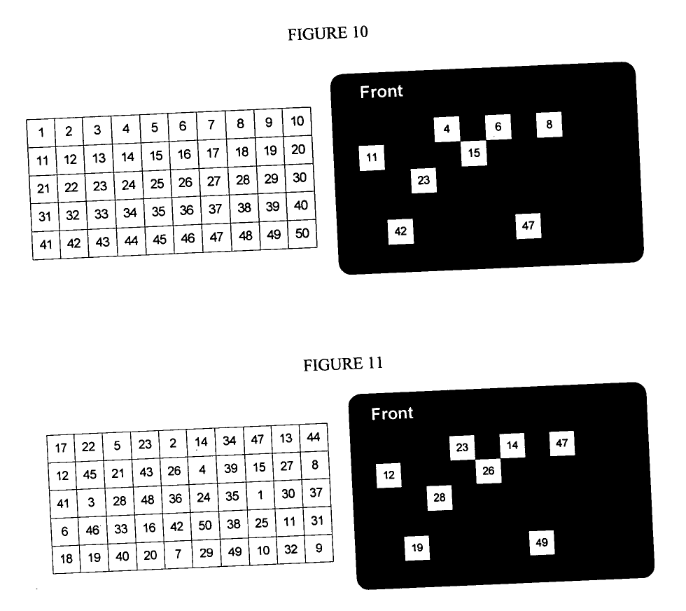

Once the scrambled matrix is displayed on the monitor, the user derives the OTP by placing his/her card over the matrix, which thereby reveals a number of matrix characters that show through the holes of the card. FIGS. 9 and 10 show unscrambled and scrambled matrices and show how they are used in conjunction with the card depicted in FIG. 6 to derive an OTP.

FIG. 10 shows an example of an unscrambled matrix and its use in conjunction with the card of FIG. 6 to derive an OTP. The left side of FIG. 10 shows an unscrambled 5×10 matrix, and the right side of FIG. 10 shows a view of the unscrambled matrix with the card placed over it, revealing the OTP characters 4-6-8-11-15-23-42-47. Thus, in FIG. 10, the user would need to enter the OTP characters 4-6-8-11-15-23-42-47 in order to complete the authentication process for this transaction. It should be noted that, in this example, the number sequence is simple, i.e., it is the key-sequence of the card, because the matrix has not yet been scrambled.

In FIG. 11, however, the left side shows a scrambled 5×10 matrix, and the right side shows a view of the scrambled matrix with the card of FIG. 6 placed over it, revealing the OTP characters 23-14-47-12-26-28-19-49. In this example, the user, presenting the same card as used in FIG. 10 but for a different online transaction (where a different, scrambled matrix is displayed), would be required to enter the sequence of characters 23-14-47-12-26-28-19-49 as the OTP in order to complete the authentication process for this transaction.

In a preferred embodiment of the invention, once the user enters the OTP that is revealed by the card, i.e., the sequence of characters that shows through holes 9, the OTP is sent back to the server. The server, using the scrambled matrix retained temporarily in its memory, then calculates the key-sequence of the card from the characters entered by the user and compares the key-sequence of the card as entered with the key-sequence that is stored in its database under the user's account, as discussed below. If the server recognizes a match of the translated OTP to the stored key-sequence, it authenticates the transaction.

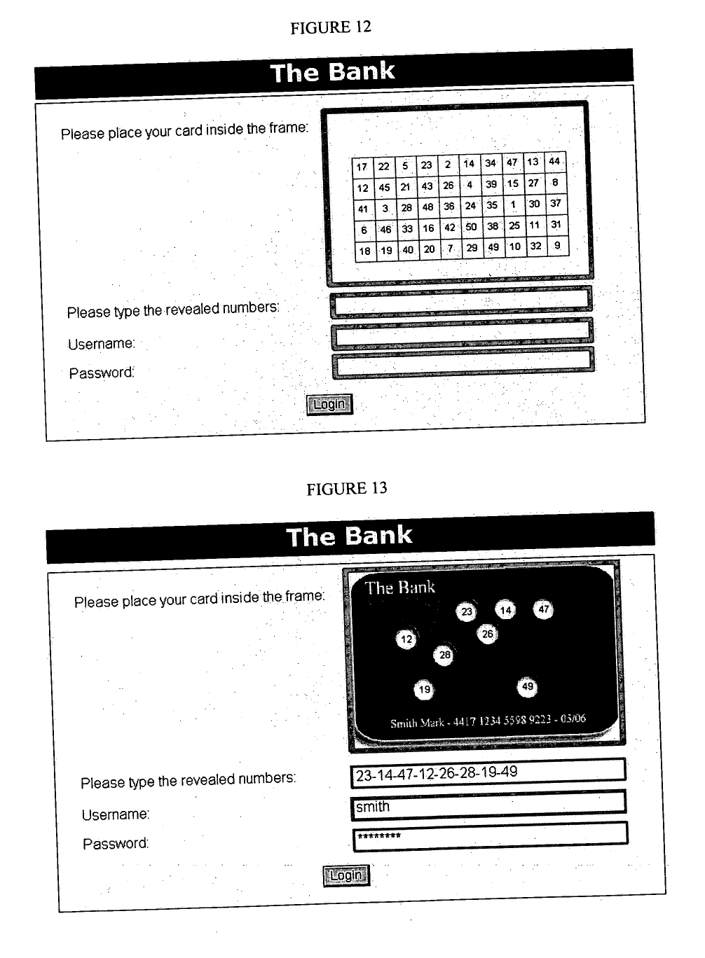

FIGS. 12 and 13 show a preferred embodiment of the appearance of the user's monitor during the typical “Challenge-Response” sequence in which the server authenticates a transaction with the OTP. In this method, the server challenges the user and the user responds in order to gain authentication. The computer monitor (or any other output device such as handheld or printer output) may be utilized as a transportation hardware device for the challenge-response.

The following are the preferred steps of the challenge-response. First, the user enters his/her username and password. Next, after the username and password are successfully verified by the server, the server challenges the user by displaying a scrambled matrix. FIG. 12 shows an example of the computer screen displaying a scrambled matrix before the user introduces the card in an online transaction. For simplicity, FIG. 12 shows the scrambled matrix of FIG. 5.

Then, the user responds to the challenge by the server by placing his/her card over the displayed matrix to reveal the OTP for the transaction. FIG. 13 shows the computer screen of FIG. 12 after the user has introduced the card in an online interaction. FIG. 13 also shows the scrambled matrix of FIG. 5 but with the card of FIG. 6 placed over it as is shown in FIG. 11, revealing the characters sequence 23-14-47-12-26-28-19-49 as the OTP. The user enters this OTP into the area on the screen provided by the server, and the server in turn determines whether the OTP entered by the user is correct, using the key-sequence for the card stored by the server. If the OTP is correctly entered, the user is authenticated and is permitted to proceed with the desired transaction. Of course, the sequence of entries described above may vary, depending on the specific implementation.

In an alternate embodiment, the monitor is a touch screen monitor and the user places the card onto the scrambled matrix on the touch screen monitor. Rather than entering the OTP vectors into a separate space provided, the user merely touches the screen through the card's holes with his/her fingertip or stylus. The client's application will capture the vector values and then submit them to the server, either with or without first displaying them to the user in the manner shown in FIG. 13.

FIG. 14 demonstrates how the server authenticates the OTP that it receives from the user with regard to the key-sequence for the user's account that is stored in the database. In FIG. 14, a 5×10 unscrambled matrix and the corresponding, randomly scrambled matrix are laid out side by side, in two separate columns, for comparison purposes. As can be seen from this layout, each number in the scrambled matrix has a corresponding number in the unscrambled matrix. This comparison chart essentially shows how the server generated the scrambled matrix, and how the OTP that the user sees, as filtered by the card, can be translated back into the card's unique key-sequence.

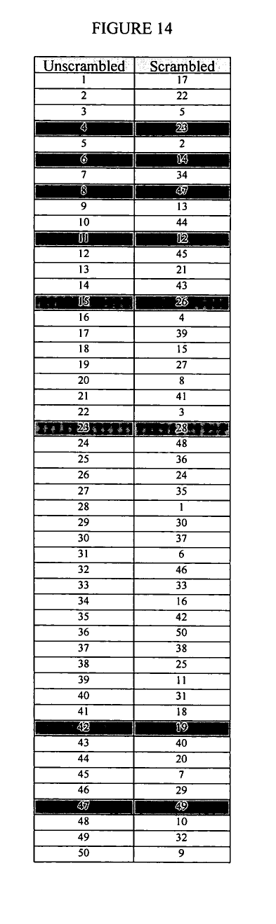

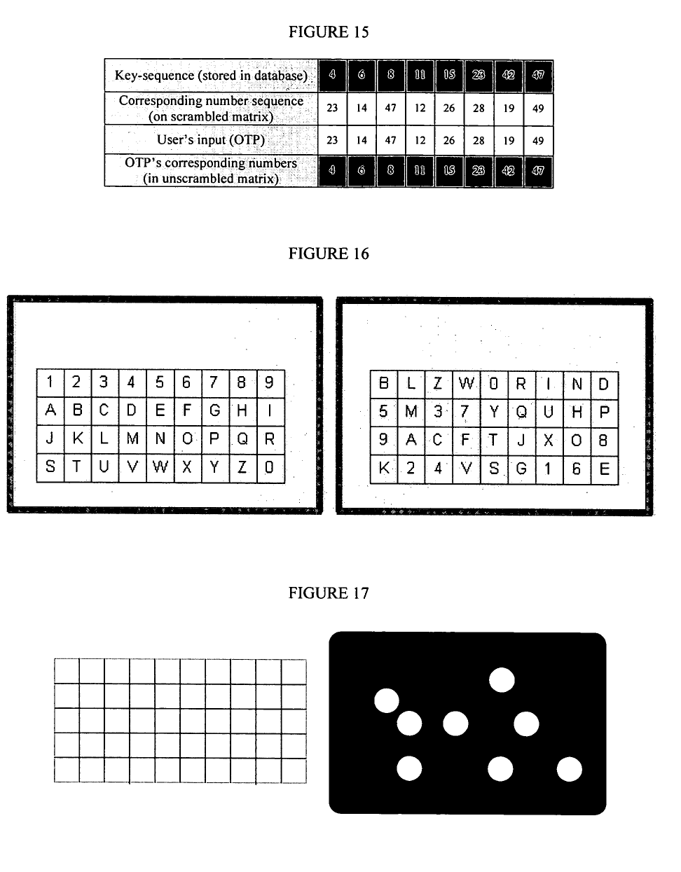

FIG. 15, as derived from FIG. 12, further shows that, using the key-sequence for the card shown in FIG. 6, as also shown in FIGS. 10 and 11, the specific key-sequence 4-6-8-11-15-23-42-47 (FIG. 15, first line) that has been stored in the database for this card corresponds to the characters sequence 23-14-47-12-26-28-19-49 (FIG. 15, second line) in the scrambled matrix. This is actually the expected OTP for this scrambled matrix using this card (FIG. 15, third line), as seen on the right side of FIG. 11.

Once the user enters this OTP, the server compares the OTP characters as entered to the corresponding sequence in the unscrambled matrix (FIG. 15, fourth line). Since the server temporarily retains the scrambled matrix until the transaction is complete, the server can convert every number from the OTP entered by the user to its corresponding character in the unscrambled matrix, using the lookup table in FIG. 14, and then compare those corresponding characters with the key-sequence stored in the database for that card. As demonstrated in FIG. 15, there is a match between the actual key-sequence stored in the database for that card and the OTP's corresponding characters. In this case, the user's identity is authenticated, and the transaction is permitted to proceed.

However, if the user types in a slightly different character sequence as the OTP, for example: 23-14-47-12-26-28-19-48, instead of 23-14-47-12-26-28-19-49, then the server will be unable to authenticate the transaction because the OTP's corresponding characters will not match the key-sequence for that card. In this instance, the incorrect entry by the user of “48” as the last number of the OTP will cause the server to interpret the corresponding characters sequence as 4-6-8-11-15-23-42-24, since “48” in the scrambled matrix corresponds to position no. 24 in the unscrambled matrix. The server will to attempt to match this corresponding character sequence 4-6-8-11-15-23-42-24 to the stored key-sequence for that card 4-6-8-11-15-23-42-47. Because the server will be unable to match this corresponding character sequence to the card's correct key-sequence, the transaction will be rejected.

Therefore, the OTP, which is the actual sequence of numbers that is revealed by the holes of the card when the card is held up to the matrix displayed on a computer monitor, is a unique sequence of numbers or characters for each transaction. Because the OTP is derived from a randomly scrambled matrix sent by the server and temporarily displayed on the user's monitor, it is called a dynamic OTP.

The strength of the OTP thus is two-fold. First, in contrast to a static password that remains the same for all online transactions, the dynamic OTP is different for every single transaction, thereby making it very difficult for an outsider to guess. Second, the OTP provides an additional layer of security as the second in the two-pronged requirement for authentication—because the OTP is derived by using a physical card, it is “something the user possesses”, in addition to the static password used in the present invention, which is “something the user remembers” and is assumed to be known only to the user. In this way, a high security level is provided. If the static password is known to someone other than the cardholder, the user will still need the physical card in order to derive the OTP and perform an online transaction. Similarly, in the opposite case, if the card were stolen, the thief would be unable to complete an on-line transaction without knowing the static password.

In an embodiment of the invention alternative to that shown in FIGS. 4-15, wherein the matrix contained a series of consecutive numbers (1,2,3 . . . . N), the matrix may instead include different forms of numbers, letter characters (A,B,C, . . . . Z) in various languages, various symbols (e.g., @,#,$,+,%,ˆ,¶,&,*, etc.), shapes or colors. In another alternative embodiment, the matrix may be mixed, i.e., it may be any combinations of numbers, letter characters, symbols, shapes or colors. In still another alternative embodiment, the matrix may have multiple numbers, letters, symbols, shapes or colors, or combinations thereof, even within individual cells.

For example, FIG. 16 shows one example of a 4×9 mixed matrix, composed of individual characters and numbers. In this example, each number or character represents a unique, two-dimensional x,y matrix location corresponding to the cells on the actual card. For example, as shown in the unscrambled matrix on the left side of FIG. 16, the number “1” represents the location x=1, y=1 (1,1), the number “8” represents the location x=1, y=8 (1,8), the character “D” represents the location x=2, y=4 (2,4), etc. The right side of FIG. 16 shows the mixed matrix of the left side of FIG. 16 in scrambled form.

As can be seen from the embodiment of the invention shown in FIGS. 4-15, there is a close relationship between the format of the matrix and the key-sequence of the card and, as a result, the physical appearance of the card. Thus, the format of the matrix dictates the physical layout of the key-sequence vectors on the card, i.e., the actual location of the punched/printed viewing areas on the card. In the embodiments of the invention previously discussed, the basic matrix is comprised of rows and columns that are oriented orthogonally with respect to each other, i.e., they intersect at 90° angles. FIG. 17 shows the standard format of a basic rectangular 5×10 matrix, wherein five rows often cells each cross at right angles, and one example of a resulting card format, in this case the physical format of a card whose key-sequence, based upon the matrix at the left side of FIG. 17, is 7-12-23-25-28-43-47-50.

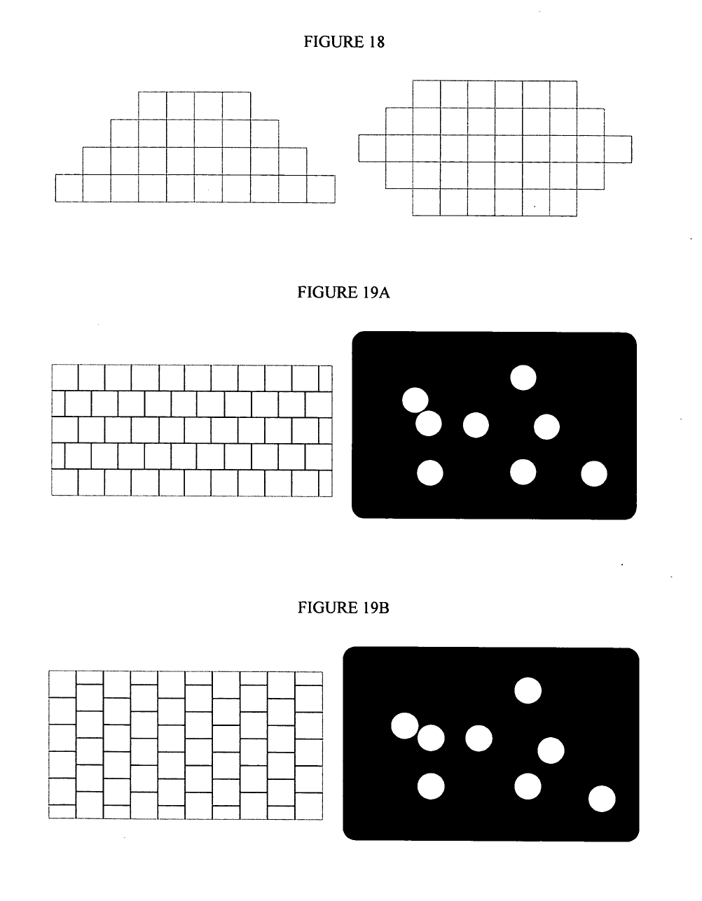

However, the graphical layout of a matrix can vary. For example, FIG. 18 shows two alternative layouts of a basic matrix, wherein the rows and columns are still oriented orthogonally with respect to each other, although the format of the matrix is not rectangular. On the left side of FIG. 18, the matrix is triangular shaped, and on the right side of FIG. 18 the matrix is somewhat diamond shaped.

Furthermore, in an alternative embodiment, the matrix may be “twisted”. In a twisted matrix, the rows and/or columns may be shifted in order to change the layout of the key-sequence on the card, such that the rows and columns are no longer necessarily oriented orthogonally with respect to each other. FIG. 19A shows a first preferred embodiment of a twisted 5×10 matrix and its corresponding card key-sequence, wherein every other row is shifted to the right by half a cell from the standard, i.e., straight, format shown in FIG. 17, i.e., the cells are not aligned so as to intersect at 90° angles. In this embodiment, the card has the key-sequence 7-12-23-25-28-43-47-50, just as in the basic embodiment shown in FIG. 17. However, as a result of the shifting of the rows, the card corresponding to this twisted matrix looks slightly different than the does the basic matrix card having that same key-sequence shown in FIG. 17.

FIG. 19B shows a second preferred embodiment of a twisted 5×10 matrix and its corresponding card key-sequence, wherein every other column is shifted down by half a cell from the standard format shown in FIG. 17. The card in this embodiment has the key-sequence 7-12-23-25-28-43-47-50, just as in the basic embodiment shown in FIG. 17 and in the first embodiment of the twisted matrix shown in FIG. 18. Again, however, as a result of the shifting of the columns, the card corresponding to this twisted matrix looks slightly different than the does the card having that same key-sequence that corresponds to the basic matrix shown in FIG. 17 and slightly different than the does the card having that same key-sequence that corresponds to the first embodiment of the twisted matrix shown in FIG. 18.

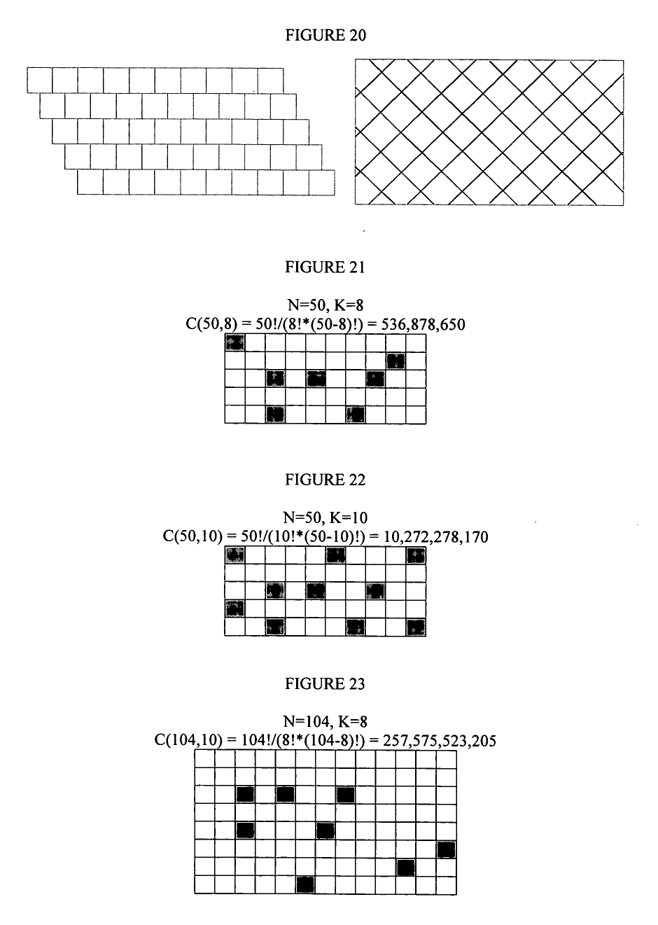

FIG. 20 shows two additional preferred examples of twisted matrices that can be utilized, one on the left side and one on the right side of FIG. 20. Of course, additional embodiments of twisted matrices can be contemplated, by varying the positions or layout of the cells of the matrix. Twisted matrices are preferably implemented in the present invention using an algorithm that shifts the positions of the cells in successive rows, and such algorithms are well known to those of ordinary skill in the art.

Alternatively, the array of characters that make up the matrix need not be oriented in row/column format, orthogonally oriented or not, but can also be arranged in other non-linear formats. For example, the characters may be arranged in a spiral configuration, such as a circle or ellipse, with characters arranged in concentric circles or spirals, each of which can be considered a row. Furthermore, the characters may be arranged in a spiral configuration, such as a circle or ellipse, with characters spiraling outward from a central location or node. In this instance, the key sequence would take an appropriate set of values, based for example upon the sequential positions of the characters from the node, with viewing portions formed at appropriate locations along the spiral. Many other types of orientations may be utilized without departing from the essence of the invention.

In all cases of twisted or non-linear matrices, similar to the standard matrix, the card is preferably to be matched against the displayed matrix to reveal the OTP when introduced during an online transaction. Although it would be very difficult for a thief to deduce the key-sequence of a particular card simply by examining an actual card, twisted matrices, which create different visual looks for different cards, can preferably be used in order to make it even more difficult (and indeed almost impossible) to visually map the exact order of the cells on the card and determine the key-sequence.

Of course, because the server, when displaying a matrix to a user, may choose from among many different possible formats, e.g., different sizes (numbers of rows and columns) or key-sequence length, non-mixed/mixed, straight/twisted, etc., the server needs a way to determine the format of the matrix to display for each particular user. In other words, a user with a card whose 8-vector key-sequence is determined based upon a 5×10 straight, numbers-only matrix would never be authenticated for transactions if the user were presented with a matrix having any other property, e.g., a different number of rows or columns, mixed content or twisted, or requiring a different number of characters in the OTP.

Accordingly, in a preferred embodiment, a matrix template can be associated with each user's account or with a group of user accounts, such that whenever a user attempts to log in, the server presents that user with a matrix layout as determined by that user's template. The template used to produce the matrix can be stored in the server database under a specific account record or group of records. In this way, in a preferred embodiment, each time a user performs an online transaction, the server will display the scrambled matrix in the predetermined layout that is relevant for that user, so that there can be a match between the actual card of that user and the displayed matrix. Likewise, the server will expect entry by the user of an OTP in the predetermined form and with the correct number of characters that is relevant for that user, so that there can be a match between the format and number of characters of the OTP that the user has entered and the predetermined key-sequence for that user's matrix template.

Matrix templates can be employed to determine the type or form of the matrix (e.g., standard or twisted), the size of the matrix (i.e., how many rows and columns), the content of the matrix (e.g., numbers, letters, characters or mixed), the numbers of characters per cell and/or the number of vectors in the key-sequence. For example, in certain embodiments, one group of cards/matrices can be produced using a matrix template that has only numbers, another group of cards/matrices can be produced using a mixed matrix template, while a third group of cards/matrices can be produced using a combination of a mixed matrix and a twisted matrix. In addition, the server will anticipate entry of by the user of the OTP in a particular format, such as the predetermined number of vectors in the key-sequence and the number of characters per key-sequence, and will refuse to authenticate a user that does not provide the OTP as expected.

As a result, matrix templates, which dictate the format in which the matrix will appear or be presented to a particular user and the number of vectors in the key-sequence, provide an alternative and optional way to increase the number of combinations and/or permutations of the scrambled matrix and/or the key-sequence, thereby increasing the strength of the key-sequence and the OTP.

Similarly, as discussed previously, the number of available vectors, measured by the size of the matrix, i.e., the number of rows and columns, will have a direct effect on the strength of the authentication process. This is because the number of possible key-sequence combinations for a particular matrix means that each OTP for that matrix has a higher chance of being non-repeatable, i.e., unique. Moreover, whether or not the characters of the OTP are required to be entered in a specific order will also impact upon the strength of the authentication process. In other words, the strength of the key-sequence and the OTP will be determined, in part, by the number of vectors of the matrix that are revealed by the holes of the card and whether or not the user is required to enter the revealed vectors in a particular sequence.

In a first embodiment, the order of entry of the characters of the OTP is NOT required, and the user may enter the revealed vectors in whatever order desired. In this case, the number of combinations available for choosing K objects out of N objects is represented by the following formula, where the variable N stands for the number of cells in the matrix, and the variable K stands for the length of the key-sequence (the number of vectors):

$$C ( n , k ) = \frac{N !}{( k ! * ( n - k ) ! )}$$

Every vector in the key-sequence represents a physical, two-dimensional (x,y) location on the card. Thus, in this embodiment where entry of a specific selection order is not required, for the key-sequence 1-2-3-4-5-6-7-8, for example, the locations of cell numbers 1 through 8 (all eight cells) would be punched/printed on the card. In the same manner, the key-sequence 2-5-1-8-6-3-7-4 would result in a card with the same physical appearance, because every vector represents the same physical location on the card (i.e., punched/printed holes that are in the same physical locations as in the previous key-sequence). Thus, where entry of vectors in a specific order is not required, the physical cards all combination of specific vectors will be identical.

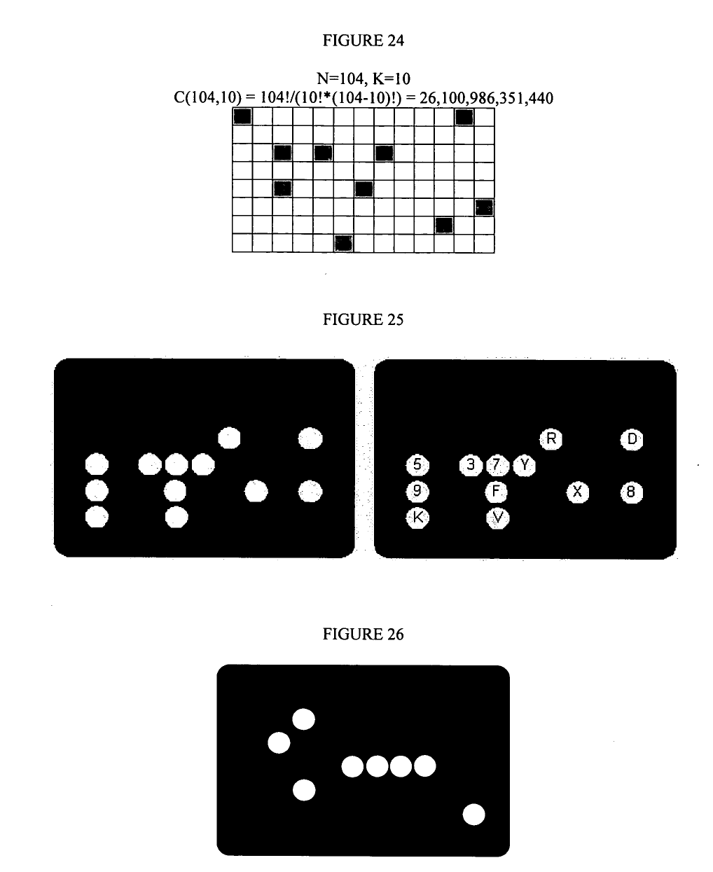

In practical terms, therefore, the value C(n,k) represents the number of different and unique cards that may be produced using the matrix with N cell locations. FIGS. 21-24 demonstrate the number of combinations, i.e., unique cards, that are available for different sized matrices and key-sequence lengths. An example of a key-sequence for each set of variables is shown in each of FIGS. 21-24. FIGS. 21 and 22 show examples of key-sequences for 5×10 matrices (with 50 cell locations) having 8 and 10 vectors, which have 536,878,650 and 10,272,278,170 possible key-sequence combinations, respectively. FIGS. 23 and 24 show examples of key-sequences for 8×13 matrices (having 104 cell locations) having 8 and 10 vectors, which have 257,575,523,205 and 26,100,986,351,440 possible key-sequence combinations, respectively.

A different number of combinations is derived if the size of the matrix is reduced but the number of vectors in the key-sequence is increased. For example, for the 4×9 mixed matrix shown in FIG. 16, along with a key-sequence length of twelve (12) vectors, provides 1,251,677,700 combinations, which is more than the number of possible combinations for an 8-vector key-sequence in a larger, 5×10 matrix having 50 cell locations, as discussed above. For this mixed matrix, a randomly generated key-sequence may be: 5-V-K-9-Y-R-D-3-X-7-F-8. A sample 12-vector card is shown on the left side of FIG. 25, and the card, after being placed over the scrambled matrix appearing on the monitor, is shown on the right side of FIG. 25. This combination of numbers and letters in a 4×9 matrix size provides a fairly strong key-sequence, yet still reserves additional space on the card for an optional magnetic strip (in a combined card implementation) and for printed information (e.g., cardholder's name, expiration date, etc.), as seen in FIG. 25.

In general, in order to increase the number of possible key-sequence combinations for a given key-sequence length, the size, i.e., the number of cells, of the matrix could be increased. Table 1 below shows the increase in the number of combinations (C(N,K)), where the order is not required, for a fixed key-sequence length (K=8), as the number of cells in the matrix (N) increases.

TABLE 1

| N | Combinations | n!/(k!*(n − k)!) |
|---|---|---|
| 50 | 536,878,650 | 50!/(8!*(50 − 8)!) |
| 60 | 2,558,620,845 | 60!/(8!*(60 − 8)!) |
| 70 | 9,440,350,920 | 70!/(8!*(70 − 8)!) |
| 80 | 28,987,537,150 | 80!/(8!*(80 − 8)!) |
| 90 | 77,515,521,435 | 90!/(8!*(90 − 8)!) |
| 100 | 186,087,894,300 | 100!/(8!*(100 − 8)!) |

Similarly, in order to increase the number of possible key-sequence combinations for a given matrix, the number of vectors in the key-sequence could also be increased. Table 2 shows the increase in the number of combinations (C(N,K)), where the order is not required, for a fixed number of cells in the matrix (N=50), as the key-sequence length (K) increases:

TABLE 2

| K | Combinations | n!/(k!*(n − k)!) |
|---|---|---|
| 6 | 15,890,700 | 50!/(6!*(50 − 6)!) |
| 8 | 536,878,650 | 50!/(8!*(50 − 8)!) |
| 10 | 10,272,278,170 | 50!/(10!*(50 − 10)!) |

Table 3 shows additional combinations of the variables N and K and the resulting number of possible key-sequence combinations, where the order is not required. Table 3 demonstrates that a matrix of 40 cells, with a key-sequence length of 16 vectors, provides quite a robust key of 62,852,101,650 possible key-sequence combinations (over 62 billion, 852 million possible combinations).

TABLE 3

| N | K | Combinations | n!/(k!*(n − k)!) |
|---|---|---|---|
| 30 | 16 | 145,422,675 | 30!/(16!*(30 − 16)!) |
| 36 | 12 | 1,251,677,700 | 36!/(12!*(36 − 12)!) |
| 40 | 16 | 62,852,101,650 | 40!/(16!*(40 − 16)!) |
| 40 | 16 | 62,852,101,650 | 40!/16!*(40 − 16)! |

However, there are certain combinations of vectors that, for practical reasons, should be excluded. For example, in order to prevent weakening or physical deterioration of the structure of the card itself due to the requirements of the key-sequence, it is preferred that certain combinations of vectors should be excluded, e.g., combinations that would cause holes on the card to be located adjacent to each other, such as shown in FIG. 26. Such combinations, such as those that would cause four or more holes are located adjacent to each other and which could weaken the physical structure of the card, may in certain embodiments be excluded.

The determination of the number of combinations available for choosing K objects out of N objects discussed above is valid only when the selection order is not important. In this case, the order of selection does not matter because each vector in the scrambled matrix represents a specific x,y value (vector) in the unscrambled matrix. Therefore, no matter what value is assigned to a specific vector when the matrix is scrambled (i.e., the order of the matrix is changed), the corresponding vectors in the unscrambled matrix (the key-sequence) will always stay the same.

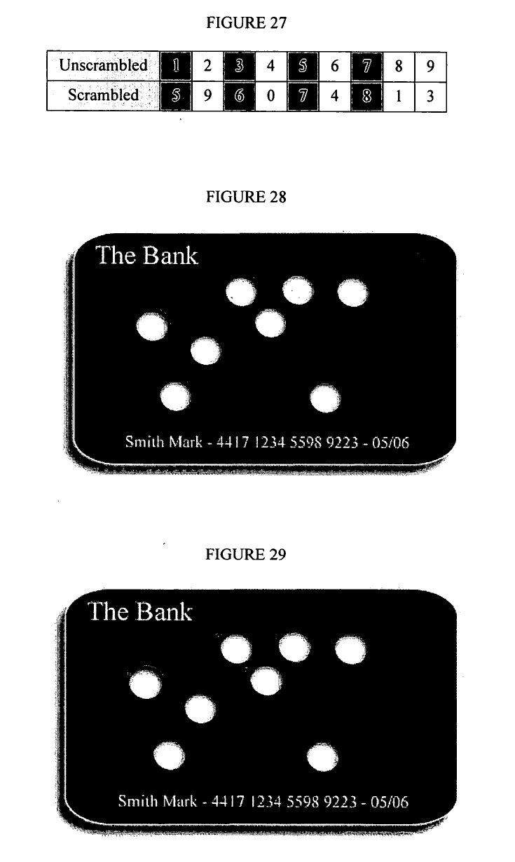

For example, this can be demonstrated using the key-sequence 1,3,5,7 and the simple unscrambled and scrambled matrices shown in FIG. 27. In this example, suppose that, using his card, the user sees on the monitor the characters: 5-6-7-8. These characters are then entered by the user as the OTP, and they converted by the server to 1-3-5-7, which matches the key-sequence. In one preferred embodiment of the present invention, wherein the sequence of digits of the OTP is not important, even if the user enters 6-5-7-8, the transaction will still not be rejected, since the actual key-sequence (as embodied by the “holes” on the card) is the same in either case.

Note that in this example, the key-sequence 1-3-5-7 is sorted in ascending order. In fact, the key-sequence that is stored in the database must be sorted, because the server does not “know” in which order the user will type in the OTP. Therefore, after the server converts the OTP to its corresponding key-sequence numbers, the result must be sorted, as discussed below, in order to ensure that the transaction is not incorrectly rejected and that a match takes place.

In order to accomplish a complete match between the key-sequence stored in the database and the OTP that is entered by the user where the order of entry of the OTP characters is not required, the following steps are necessary. First, a key-sequence that is generated for a new account needs to be sorted. Second, the user is permitted to enter the OTP in any order desired. Third, the server then converts the OTP into the corresponding numbers of the unscrambled matrix and sorts the result. For example, with reference to the example of FIG. 27, if the user typed in 6-8-5-7 as the OTP, the server would convert the OTP to 3-7-1-5. This result would then be sorted by the server to 1-3-5-7, a result which matches the key-sequence.

In general, the strength of the OTP alone (independent of the static password) is measured by the probability that any specific OTP will be repeated. In the present invention, this translates into the chance that an outsider might guess the OTP for a certain transaction.

The probability that an outsider will be able to guess the OTP, where the order is not required, is represented by the formula 1/C(N,K). With reference to Table 3 above, which presents examples of the resulting combinations for different sized matrices (N) and different key-sequence lengths (K), Table 4 below shows the probability of someone guessing any one of the combinations resulting in Table 3.

TABLE 4

| N | K | Probability | 1/C(N,K) |
|---|---|---|---|
| 30 | 16 | 0.00000000687 | 1/145,422,675 |
| 36 | 12 | 0.000000000798 | 1/1,251,677,700 |
| 40 | 10 | 0.00000000117 | 1/847,660,528 |
| 40 | 16 | 0.0000000000159 | 1/62,852,101,650 |

Similarly, in a matrix of 36 cells and an even shorter key-sequence length of 8 vectors, the probability of guessing an OTP is:

$$\frac{1}{C ( n , k )} = \frac{1}{( n ! / ( k ! * ( n - k ) ! ) )} = \frac{1}{( 36 ! / ( 8 ! * 28 ! ) )} = \frac{1}{\text{30,260,340}} = 0.000000033$$

Although this is a rather miniscule and statistically insignificant probability, there are various ways to make it significantly even smaller, at differing levels of tradeoff between security and user friendliness, as discussed below.

One way to further strengthen the OTP is the second embodiment, wherein a specific order of entry of the OTP characters IS required, i.e., that the server requires the user to enter the characters in a particular order in order for the OTP to be accepted as valid. In this second situation, where the selection order of the key-sequence vectors entered by the user as the OTP IS important, the number of permutations available for choosing K objects out of N objects is represented by the following formula, where the variable N stands for the number of cells in the matrix, and the variable K stands for the length of the key-sequence (number of vectors):

$$C ( n , k ) = \frac{n !}{( ( n - k ) ! )}$$

When compared to the formula set forth previously for the number of combinations when the selection order is not important, in this formula the value K! does not appear in the denominator. Therefore, in pragmatic terms, adding the dimension of the order multiplies the number of possible combinations of characters of the OTP by K!.

For comparison purposes, the number of OTP combinations in a matrix of 36 cells and a key-sequence length of 8 vectors when the order is NOT required is 30,260,340, as set forth above. However, when the order of vectors IS required, the number of OTP combinations is:

$$C ( 36 , 8 ) = \frac{36 !}{( 36 - 8 ) ! )} = \text{1,220,096,908,800,} which is \text{30,260,340} * 8 ! .$$

Thus, adding the importance of the selection order makes the probability of guessing an OTP much smaller, because the k! is no longer exists in the denominator. Thus, in a matrix of 36 cells and an even shorter key-sequence length of 8 vectors, the probability of guessing an OTP in this situation is much smaller, represented by the formula:

$$\frac{1}{C ( n , k )} = \frac{1}{( 36 ! / ( 36 - 8 ) ! )} = \frac{1}{\text{30,260,340} * 8 !} = 8.196070269397932 e \text{-} 13$$

This probability is significantly smaller than in the first embodiment, where the selection order of the vectors is not important. A greater number of combinations, and a smaller probability of guessing the OTP, is provided if the user is instructed to enter the OTP in one specific order, for example from left to right along the rows, and from top row to bottom row.

In the first embodiment, the order in which the user types in the OTP was not important, and the server sorts the OTP in order for it to match to the key-sequence. However, making the order of entry of the OTP characters important provides even stronger protection to the user by increasing the possible number of combinations of the OTP and thus a smaller chance to guess it. In the second embodiment, the server will NOT sort the OTP. Instead, when a new card is created, the key-sequence is created in a specific order, the server will not sort the key-sequence before storing it in the database, as described previously for the previous embodiment.

In order to accomplish a complete match between the key-sequence stored in the database and the OTP that is entered by the user where the order of entry of the OTP characters is required, a key-sequence that is generated for a new account first needs to be sorted. Then, the user is requested to enter the OTP in a specific order (e.g., from left to right along each row, and from top row to bottom row). In effect, by entering the OTP in a specific order, the user himself performs the sort that the server performs in the first embodiment, and a match can take place.

Consider again the example of FIG. 27. If the sequence order of the digits entered as the OTP were important, then entry by the user of the OTP characters 5-6-7-8 in a different order would not yield an authenticated transaction because the resulting key-sequence would not match the stored key-sequence. Thus, if the user entered an OTP with exactly the same characters but in a different order, such as 6-5-7-8, the server would convert the OTP to the key-sequence 3-1-5-7, which is a different result than the actual key-sequence 1-3-5-7, and this transaction would be rejected.

For further illustration, consider the example as shown in FIG. 13, wherein the same individual vectors can yield two different key-sequences, if the required order of entry is different. When the order is not required, the server sorts the key-sequence at the time of creation of the card prior to storing it in the database, e.g., in ascending order, as 4-6-8-11-15-23-42-47, and the user may then enter the OTP characters in any order. After OTP entry, the server would re-sort the matrix and generate the result 4-6-8-11-15-23-42-47. Thus, in such a situation, this is actually the only one key-sequence.

However, when the order is required, the user is required to enter the OTP characters in a specific order. If the user were required to enter the OTP characters from left-to-right and then top-to-bottom according to what is seen through the card in FIG. 13, he would be required to enter the OTP characters in the following order: 23-14-47-12-26-28-19-49. If the user were required to enter the OTP characters from top-to-bottom and then left-to-right according to what is seen through the card in FIG. 13, he would be required to enter the OTP characters in the following order: 12-19-28-23-26-14-49-47. As a result, these two combinations would be two different OTPs, even though the individual vectors are the same.

Thus, the probability of guessing an OTP can be made smaller by increasing the possible number of permutations, or orders, for each combination of vectors in a key-sequence. When the dimension of sort order is added to the number of OTP combinations, the number of new combinations is represented by the formula: Combinations=O*C(n, k), wherein O represents the number of different sort orders available and C(n,k) represents the number of OTP character combinations, the formula for which is set forth above.

In the previous example, using a matrix of 36 cells and a key-sequence length of eight vectors, there were 30,260,340 possible OTP combinations where the order was not considered. However, if two different orders are employed, e.g., ascending and descending, the number of combinations will be doubled and will increase from 30,260,340 to 60,520,680. Similarly, if there are four different orders, e.g., ascending, descending, first odd and then even numbers once in ascending and once in descending order, the number of combinations will be quadrupled and there would be 4*30,260,340=121,041,360 combinations. Table 5 below illustrates these four different orders for an OTP with a key-sequence of 15-9-30-5-35-2-7-16:

TABLE 6

| Order | OTP |
|---|---|
| Ascending | 2-5-7-9-15-16-30-35 |
| Descending | 35-30-16-15-9-7-5-2 |
| Ascending, first odd and then even | 5-7-9-15-35-2-16-30 |
| Descending, first odd and then even | 35-15-9-7-5-30-16-2 |

Many different, arbitrary orders can be implemented in the same manner, as needed. For example, as discussed before with regard to FIG. 13, from left-to-right and then top-to-bottom, or from top-to-bottom and then left-to-right. A total of one hundred different orders would bring the number of possible OTP combinations to 100*30,260,340=3,026,034,000, and the probability of guessing such an OTP would then be 1/3,026,034,000=0.00000000033. In essence, by applying 100 different orders to the key-sequence, the number of OTP combinations is easily increased one hundred-fold

These different orders can be employed in further preferred embodiments of the invention to increase the security of the key-sequence by using “order templates”, which dictate the sequence in which the characters of an OTP must be entered by a user in order to be accepted by the server, wherein a specific order is associated with a specific user's account or with a group of users' accounts. In this embodiment, similar to the use of a matrix template discussed above, each user would preferably have an “order template” associated with his account. When creating a new account, the order template type is preferably stored in the database of the server under the user's account, for example: Type-00, 01, 02, . . . 99. In one embodiment, the order template for a new user can be randomly chosen from a pool of predefined templates when generating a new account.

Then, in a preferred embodiment of the invention, each time a user performs an online transaction, the server will expect entry by the user of an OTP in the predetermined order according to the order template that is relevant for that user. If the OTP characters are entered in the predetermined order according to the order template, there is then a match between the format or order of the OTP entered and the predetermined key-sequence for that user's matrix template. If not, the transaction is not authenticated

In further preferred embodiments, the user may be required to enter the order template type along with the OTP. In a still further embodiment, the order template type can be either memorized by the user or can be printed on the card itself. FIG. 28 shows an embodiment of the card wherein the order type, in this case the number 78, is printed on the card, in this case at the top-right-hand corner thereof.

In a further embodiment, the card itself may inform the user the specific order in which to enter the matrix characters to form the OTP. FIG. 29 illustrates a card, the same card as in FIG. 3, having printed on thereon the OTP character entry order. In this embodiment, the order entry is provided in the form of sequential characters, such as numbers or letters, printed next to the key-sequence vector viewing areas (holes) to inform the user of the order in which he/she is required to type in the OTP. For example, as shown in FIG. 29, the card contains the number “1” next to the view area for vector location 11, to instruct the user that, when the card is placed on the displayed matrix, the number revealed in cell number 11 should be typed in first. Similarly, the card contains the number “2” next to the view area for vector location 23, to instruct the user that, when the card is placed on the displayed matrix, the number revealed in cell number 23 should be typed in second, etc. In the embodiment shown in FIG. 29, the order in which the OTP characters are to be entered is 11-23-42-4-8-6-47-15 (using the unscrambled matrix as shown in FIG. 10 for reference), which is in effect the key-sequence. If the user enters the characters of the OTP in an order other than the order dictated by the numbers printed next to the holes, the OTP will not be recognized by the server.

In a still further but somewhat simpler embodiment, the user can be issued a card that is to be used on one of the two sides, i.e., either front or back. As can be seen from the arrangement of viewing portions 9 on the cards shown in FIGS. 6 and 7, which show the same card and its holes but from opposite sides, a single card will yield a different OTP when placed over the same matrix, depending upon which way the card is facing when placed over the displayed scrambled matrix. Accordingly, each card will have one key-sequence when used from the front and another, different key-sequence when used from the back. Thus, in order to further confound potential hackers, in this embodiment, each card would have two different key-sequences, one for when the front of the card is used and one for when the back of the card is used. In one embodiment, the server would instruct the user to place the card over the matrix either front side up or front side down, and, when the user enters the revealed OTP, the server would use the appropriate side's key-sequence for verification of the OTP. In another embodiment, the server would have a “side template” for each user and only the user would know whether the card is to be used from the front or from the back. In this embodiment, the server knows the appropriate key-sequence for each side of the card.

In preferred embodiments, this invention also provides for solutions to attacks intended to compromise key-sequence security. In the event that a hacker is somehow able to copy a displayed matrix and to spoof the OTP in the same transactional session, he/she can easily calculate the key-sequence by matching the OTP to the matrix. For example, the OTP for the card used to log a user into a bank in FIG. 13, as shown against a scrambled matrix in FIG. 11, is: 23-14-47-12-26-28-19-49. Every characters from the OTP can be easily mapped to its actual location on the unscrambled matrix, as shown in FIG. 10. Thus, the resulting key-sequence derived is: 4-6-8-11-15-23-42-47.

Another preferred embodiment of this invention that provides for solutions to attacks intended to compromise key-sequence security is called a dynamic vector. In a preferred embodiment, rather than displaying a unique character at each two-dimensional vector location on the matrix, the matrix displays groups of identical characters scattered among the matrix's two-dimensional locations, such that each character in the matrix repeats a specific number of times. This type of configuration “breaks” the one-to-one linkage, wherein every key-sequence vector represents a unique two-dimensional location in the matrix, and allows multiple key-sequence vectors to represent the same matrix character.

In the following examples of this embodiment, we will refer to the vectors that represent unique two-dimensional locations on the matrix as “two-dimensional unique vectors” and the vectors that repeat as “repeat-vectors”.

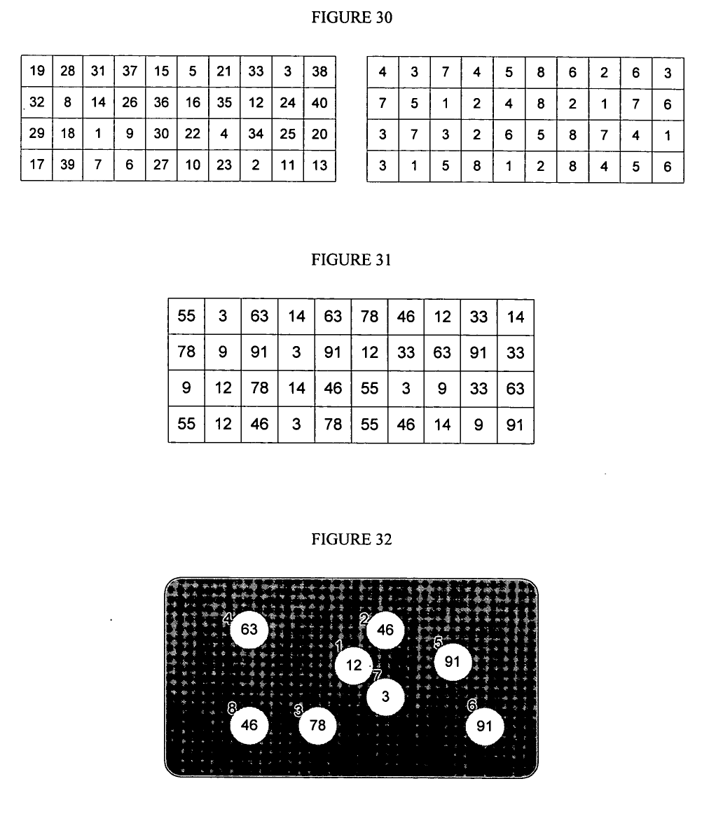

In the first example, shown in FIG. 30, a 40-cell, scrambled, two-dimensional unique vector matrix is shown on the left, and a 40-cell, scrambled, repeat-vectors matrix is shown on the right. It should be noted that, in the two-dimensional unique vectors matrix, each number is unique in that it represents a two-dimensional location of the cell in the matrix and appears only once, whereby, in the repeat-vectors matrix, there are eight numbers, and every number repeats five times at random locations within the forty two-dimensional matrix locations.

In the creation of a repeat-vectors matrix, the server might pick any sequence of random numbers, with any number of repetitions. For instance, the server randomly could choose ten numbers, with every number repeating four times. In one example, the numbers randomly chosen by the server as repeating characters for the matrix are 3, 9, 12, 14, 33, 46, 55, 63, 78, 91, and the scrambled matrix may appear as shown in FIG. 31. As discussed below, when the repeat-vectors matrix embodiment is used by a customer, a potential hacker that was able to overcome the difficulties and was able to “sniff” the OTP that was typed in, as well as to snap the displayed matrix in the same transactional session, will still be unable to match the OTP to the matrix (and thereby, to compromise the key-sequence), since there are many options for each specific match.

As usual, the key-sequence is randomly generated by the server and stored, as is, in the database. When used with the embodiment of the invention discussed previously wherein the order of OTP entry is printed on the card, as shown in FIG. 29, a number is printed next to each view portion printed on or punched through the physical card. This number represents the sequence in which the user should enter as the OTP the matrix characters viewed through the view portions of the card (the characters revealed by the card's vectors, in the order designated by the printed numbers, determine the OTP).

For example, for the key-sequence 16, 7, 35, 3, 19, 40, 27, 33, FIG. 32 shows a card with viewing portions at the appropriate key-sequence vector locations. In FIG. 32, the card also bears the number “1” printed or imprinted adjacent to the view area for vector location 16, as shown on the card in FIG. 32, to instruct the user that, when the card is placed on the displayed matrix, the character revealed in cell number 16 should be typed in first. Similarly, the card contains the number “2” adjacent to the view area for vector location 7, as shown on the card in FIG. 32, to instruct the user that, when the card is placed on the displayed matrix, the character revealed in cell number 7 should be typed in second, etc. And so on for numbers 3-8 printed adjacent to the view area for vector locations 35, 3, 19, 40, 27 and 33. For this specific transaction, when the card in FIG. 32 having the key-sequence 16, 7, 35, 3, 19, 40, 27, 33 is used with the matrix of FIG. 31, the OTP to be typed in is: 12-46-78-63-91-91-3-46.

Here, a potential hacker would be trying to match the OTP: 12-46-78-63-91-91-3-46 to the matrix, since the hacker does not have the physical card. In the case of a two-dimensional unique vectors matrix, the match would be obvious to the potential hacker, since the hacker might have already been able to snap the displayed matrix. However, with a repeat-vectors matrix, there are many combinations of vectors on the displayed matrix that could combine to compose the same OTP, and the hacker does not know which cell in the matrix is the match for a specific character or digit from the OTP. Moreover, the hacker does not know what the typing order should be, because this information is printed on the card itself.

It should be noted that this method may be used with or without the typing order printed on the card itself. In one preferred embodiment, where the order is not printed on the card, the same algorithm might be used as explained previously. When the order is required, the number of combinations is greater.

In order to accomplish the method discussed, a unique algorithm must be employed on the server side. In summary, for the described embodiment, a new, randomly generated key-sequence is stored “as is” in the database. The key-sequence is then converted into a graphical representation that defines the physical, two-dimensional layout of the viewing areas on the card. Next to each hole, a number that represents the typing order is printed. When a user types in the OTP, the OTP is sent to the server. In order for the server to find the correct match between the OTP and the key-sequence, the server reads the key-sequence for the specific user from the database and applies the following algorithm:
1. Fetch key-sequence (specific for the current user) from the database;
2. Scan the key-sequence in a loop and, for every vector, obtain the number from the scrambled matrix, where the current vector represents an index locator (1 through 40) on the matrix;
3. Add the number to a temporary string array storage (in the computer memory);
4. If end of key-sequence, go to next step, otherwise, go to the next vector; and
5. Compare the result to the OTP.

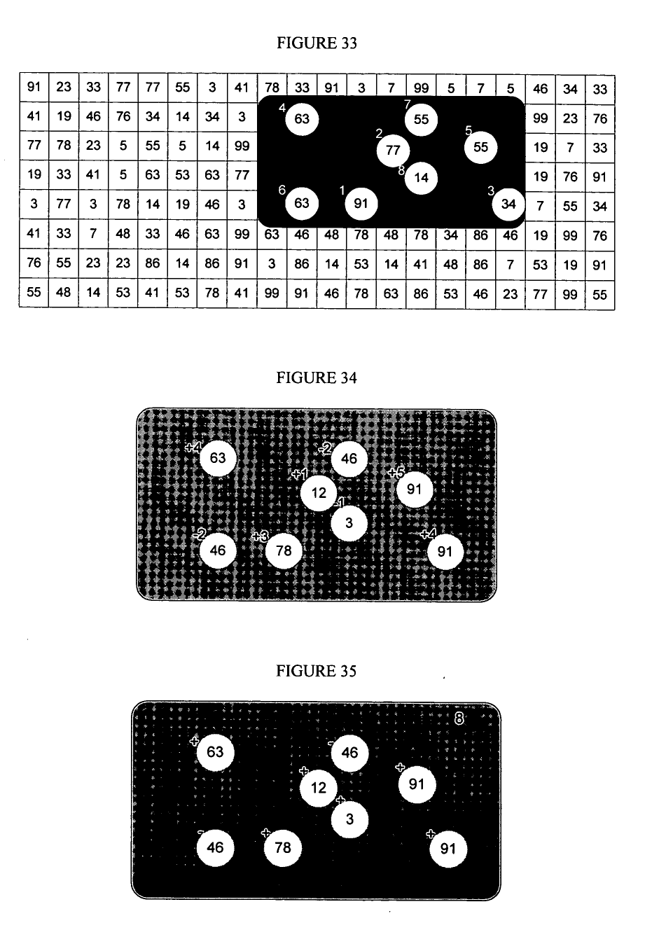

In another preferred embodiment of the repeating vectors embodiment, the matrix may be larger than the size of the matrix that matches the card. For example, the matrix may be several times the size of the card. For example, in the embodiments shown in FIG. 33, a matrix of 160 cells in 20×8 format is used. In this example, for instance, the server randomly generates twenty numbers, and every number repeats eight times. The numbers randomly generated are: 46, 55, 78, 14, 3, 91, 33 63, 5, 77, 86, 99, 41, 7, 53, 48, 23, 19, 76, 34, each of which numbers repeats eight times. In such an embodiment, the user may decide where on the matrix to place the card, and the OTP is generated according to the specific location within the matrix where the user places the card.

In this example, the card in FIG. 33 appears similar to that in FIG. 32, i.e., it has the viewing areas at the same vector locations. In addition, in this example, similar to the embodiment shown in FIG. 32, the order of OTP entry is printed on the card, as shown in FIG. 33, by way of a number printed adjacent to each vector viewing area in the card. As a result, the card in this example has the key-sequence: 35-16-40-3-19-33-7-27. As shown in FIG. 33, when this card is used with the matrix of FIG. 33 and placed in one specific location within the matrix, the OTP to be typed in is: 91, 77, 34, 63, 55, 63, 55, 14.

In order for the server to match the typed in OTP, the server will scan all possible options of where that card might be placed on the matrix. In this example, there will be more than one possible matching OTP, and the server will accept any OTP that results for any location on the matrix where the card may be placed. In fact, the number of acceptable OTPs for a specific card on a specific matrix is represented by the formula (Mₓ−Cₓ+1)*(M_{y}−C_{y}+1), where:
Mₓ represents the number of horizontal cells in the matrix;
M_{y} represents the number of vertical cells in the matrix;
Cₓ represents the number of horizontal cells in the card; and
C_{y} represents the number of vertical cells in the card.

Thus, the number of acceptable OTP's in the example shown in FIG. 33 is: (Mₓ−Cₓ+1)*(M_{y}−C_{y}+1)=(20−8+1)*(8−4+1)=13*5=65. It should be notes that having such a large number of acceptable OTPs weakens the OTP for any particular card. However, on the other hand, using a repeating vector embodiment certainly strengthens the security of the key-sequence against Trojan-Horse and Key-Logger attacks.

In another preferred embodiment that protects against attacks intended to compromise key-sequence security, the card contains an indication of an arithmetic adjustment that the user is required to make to the characters of the matrix that are seen by the user through the card's viewing portions in order to derive the OTP. This arithmetic adjustment “hides” the one-to-one linkage between the two-dimensional location that every vector represents for every cell in the matrix and the typed in OTP.

In a preferred embodiment, as shown in FIG. 34, adjacent to every viewing area (“hole”) on the card, in addition or in place of the order entry indication, a number and required arithmetic action will be printed. The number and arithmetic action instruct the user as to the required action that is to be taken on the matrix characters revealed by the card's viewing portions. Thus, when the user holds the card against the matrix, before typing the revealed characters as the OTP, the user must first make some minor calculations by applying the arithmetic action to the printed number (the operand) and the revealed character in the specific vector. The sequence of characters that results from all the arithmetic actions that are taken is the OTP for that transaction.

The arithmetic actions might be anything like: ‘+’ (add), ‘−’ (subtract), ‘*’ (multiply), ‘/’ (divide) or any other action. For example, in FIG. 34, the card shown has the key-sequence vectors 3,7,16,19,27,33,35,40. However, adjacent to vector 3 is the arithmetic operation ‘+’ and the number (operand) 4, which means that the user is to add 4 to the matrix character that is revealed through that vector. Similarly, adjacent to vector 7 is the arithmetic operation ‘−’ and the number (operand) 2, which means that the user is to subtract 2 from the matrix character that is revealed through that vector. The remaining vectors 16, 19, 27, 33, 35, 40 of the key-sequence likewise have adjacent arithmetic operations and operands that instruct the user as to the operations to be taken on the respectively revealed matrix characters.

In the case of FIG. 34, reading from left to right and top to bottom along the key-sequence vectors 3,7,16,19,27,33,35,40, the revealed characters are: 63,46,12,91,3,46,78,91. Using the appropriate arithmetic operations and operands corresponding to each key-sequence vector, the OTP to be typed in by the user will be: 67,44,13,96,2,44,81,95 (based on the following arithmetic operations: 63+4, 46−2, 12+1, 91+5, 3−1, 46−2, 78+3, 91+4).

In the case where the order entry numbers are also desired, the card could bear both. For example, the order entry digits could be printed adjacent to the key-sequence vector viewing area on one side, and the arithmetic operations and the arithmetic operands could be printed adjacent to the key-sequence vector viewing area on the other side. This indicates to the user the arithmetic operation that is to be taken on the revealed matrix character ion order to derive the OTP character, and the order in which the derived OTP characters are to be entered by the user.

The printed numbers and arithmetic actions can be randomly generated by the server for every new card prepared, and will be saved under the user's account. In that way, the server will apply exactly the same arithmetic actions on the key-sequence vectors and will compare it to the typed in OTP.

An alternative version of this embodiment is to assign for every card a one or two digit code that is to be the operand for every arithmetic operation taken with respect to that card. That operand could be printed on the card itself or could be memorized by the user. In addition, in this embodiment, only the arithmetic operation is printed on the card, adjacent to its respective key-sequence vector viewing area.

Thus, as shown in FIG. 35, as in FIG. 34, the card has the key-sequence vectors 3,7,16,19,27,33,35,40. However, the user's code, i.e., the operand, ‘8’ is printed at the top right hand corner of the card. In this case, adjacent to vector 3 is the arithmetic operation ‘+’, which means that the user is to add 8 to the matrix character that is revealed through that vector. Similarly, adjacent to vector 7 is the arithmetic operation ‘−’, which means that the user is to subtract 8 from the matrix character that is revealed through that vector. The remaining vectors 16, 19, 27, 33, 35, 40 of the key-sequence likewise have adjacent arithmetic operations that instruct the user as to the operations to be taken on the respectively revealed matrix characters using the operand 8.

In the case of FIG. 35, reading from left to right and top to bottom along the key-sequence vectors 3,7,16,19,27,33,35,40, the revealed characters are: 63,46,12,91,3,46,78,91. Using the appropriate arithmetic operations corresponding to each key-sequence vector and the operand 8, the OTP to be typed in by the user will be: 71, 38, 20, 99, 11, 38, 86, 99 (based on the following arithmetic operations: 63+8, 46−8, 12+8, 91+8, 3+8, 46−8, 78+8, 91+8).

Still another referred way to protect against key-sequence attack is to use a blank matrix. In this method, every vector in the matrix is assigned a specific value (e.g., numerical, character, etc., as usual), and, rather than displaying the values, the server will display a blank matrix instead. Preferably, the value of each vector will be hidden from the user, and every cell will be able to accept mouse or touch-screen events. In this way, the user will place the card on the monitor inside the matrix frame and click the mouse or touch the screen (e.g., using a finger or a stylus) over every key-sequence hole. The clicks of the mouse or screen touches into the card holes serve as entry by the user of the OTP, and the mouse clicks or screen touches can even be entered according to the order template for that user. The client side application will translate the mouse-click or screen touch events into their hidden vector values and submit the OTP to the server. The server will then calculate the key-sequence from the OTP in the usual manner. By employing this algorithm, even if a hacker has spoofed the OTP, the hacker could still not snap the matrix and match the OTP to it to calculate the key-sequence.

Yet another preferred method for protecting against a key-sequence attack is to employ a certain algorithm that involves clock or time sync between the server and the client. In this way, the user, for example, will have to recall a constant that might represent a unique time stamp that was applied to the account at the time the account was created. By employing this algorithm, even if a hacker has spoofed the OTP, the hacker would still have to know additional data that is known only to the user and would have to input this information at the time of the transaction.

In general, a new card must preferably be issued for each new or existing account that is added to the system. A user's account is created when the account, along with the user's personal information (e.g., name, phone number, mailing address, e-mail address, password/PIN, etc.) and the user's credentials are stored in the server database. A number of methods for creating user accounts and managing passwords are available in the market, depending on the application.

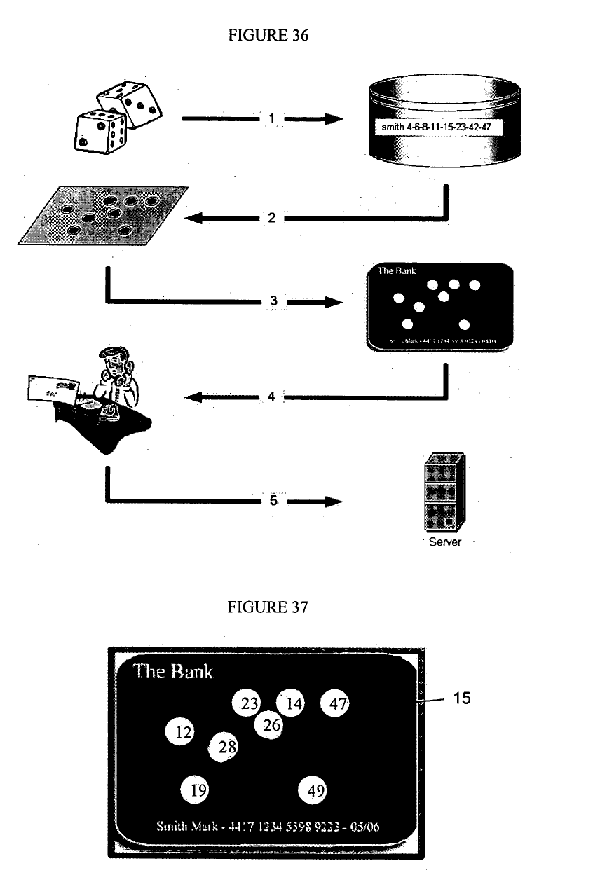

In order to create a new card, a typical process for which is depicted in FIG. 36, several steps must preferably be taken. First, a key-sequence is randomly created and stored encrypted in the server database under the user's account (step 1). If various algorithms such as matrix templates and/or key-sequence order templates are applied, this information must be stored as well. The key-sequence is then translated into a two-dimensional, graphics based pattern based upon a standard matrix or upon the matrix template (step 2). Depending on the desired format and implementation, a new physical card is produced (step 3) by forming selected viewing portions through an opaque view-blocking material, as discussed previously with regard to FIG. 6, such as by printing a graphical pattern on a plastic film, portions of which are transparent, or by punching holes through an opaque card (such as a credit card). Placement directions, which illustrate to the user the correct way to place the card on the monitor, can be printed on the actual card, as well. The card is then mailed to the user (step 4), and the user activates the card prior to using it (step 5), such as by telephone or on-line.

Because the card is meant to provide security for transactions over the Internet and protected networked systems, however, some basic security measures must be taken into account. First, because a card becomes increasingly likely to be compromised the longer it is physically possessed by one user, each card should preferably have an expiration date, after which a new card with a new key-sequence and a new pattern of holes must be issued for that user. Similar to resetting of a user's password/PIN, this lowers the risk that the key-sequence of the card or its pattern of holes will be compromised.

In addition, a timeout-lock mechanism should preferably be set for every transaction, whereby, for each transaction, the server will trigger a timeout clock that allows a preset amount of time during which the user must complete the log-in. Thus, the OTP must be entered by the user and returned to the server within the time allotted, e.g., 60 seconds, or else the transaction will be rejected. This mechanism helps to prevent a potential hacker from “stealing” a specific transaction session and tampering with the transferred data.

Similarly, a retries-lock mechanism should preferably also be set for every transaction. In this case, if a user enters an incorrect OTP repeatedly, i.e., for a pre-determined number of times, e.g., three, the server will cancel the current transaction and re-challenge the user by displaying a new scrambled matrix. After another pre-determined number of retries, e.g., six, the server will lock the account. This mechanism is intended to prevent a “brute force” attack by a potential hacker, who runs a program that feeds the server with a large number of possible OTP combinations and repeatedly tries combinations of numbers in an attempt to guess the OTP. Thus, if a hacker has stolen a user name and its associated PIN code from an individual owning a card and tries to guess the OTP by typing in different combinations, the hacker will, in a preferred embodiment, have only a limited number of attempts, after which the server will temporarily lock the account.

An additional basic security measure that may preferably be taken is the encryption of communications between the client and the server in order to prevent a potential hacker from determining the key-sequence through interception of communications. Furthermore, in order to prevent a potential hacker from scanning the displayed vectors in a matrix, the matrix may be converted, preferably into a bitmap image or Flash-based application in run time, at the server side, prior to displaying it to the user. In addition, the key-sequence should preferably be stored hashed/encrypted in the database, and the OTP should be hashed/encrypted on the client side before it is transmitted from the client's computer to the server.

In general, the card in the preferred embodiments of the present invention may be used from any setting and from any computer or monitor. Therefore, in order for the user to be able to properly use the card, there must be an exact match between the matrix displayed on the user's monitor and the physical card, regardless of the size of the monitor, the monitor's dot pitch or the monitor's display resolution. If such a match between the card and the matrix is not achieved, the numbers, letters or characters of the scrambled matrix might not be revealed through the holes of the card or might be revealed incorrectly, causing the user to enter the wrong OTP.

There are several ways in which to achieve a complete match between the card and the displayed matrix. Typically, a computer monitor displays text or graphics as a series of illuminated dots in a certain resolution. A typical monitor has a physical dot size, which is the smallest physical display unit of the monitor's screen, the most common of which are 0.28 mm, 0.25 mm and 0.23 mm. A display resolution is defined as the number of pixels per inch (ppi). A pixel is a logical display unit of the monitor's screen and (depending on the displayed resolution) might be composed of one or more physical dots. Monitors usually support resolutions of from about 640×280 to about 1280×1024 ppi.

One preferred way in which to achieve a match between the card and the displayed matrix is to use programming tools/technologies on the client's end application to provide a rendering of the actual size of a window in run time, according to the dot size of the monitor and/or the displayed resolution. For example, if the server has programmed that the size of the user's card is 85×60 mm, the application will display an exact 85×60 mm framed matrix onto which the user places his/her card. This is shown in FIG. 37, wherein the card is shown bound by frame 15 that matches the size of the card, such that the characters of the matrix are displayed within the holes of the card.

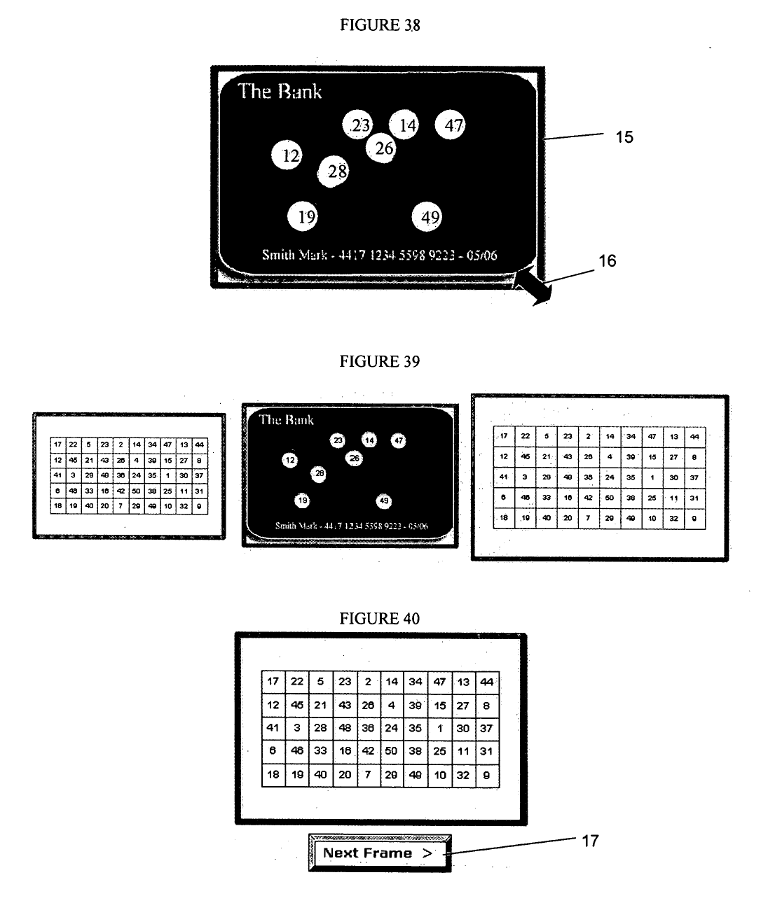

Another preferred way in which to achieve a match between the card and the displayed matrix is to use a re-sizable frame. When the re-sizeable frame is displayed, the user will need to adjust the frame's size to match the size of his/her card, as necessary. This is shown in FIG. 38, wherein the user uses his mouse or other means, such as arrow 16, to adjust the size of frame 15 so that frame 15 matches the size of the card and so that the characters of the matrix are displayed within the holes of the card.

A further preferred way in which to achieve a match between the card and the displayed matrix is to display more than one frame on the screen, with each frame representing a different common dot size, as shown in FIG. 39. Based on the differing dot sizes and considering the currently displayed resolution, the client side application will render the exact framed matrix in run time. The user will then place his/her card on the frame that best fits the card.

Alternatively, in another preferred embodiment, instead of displaying all the frames on the screen, the client end will display only one frame at a time. As shown in FIG. 40, the user will is then able to leaf through the available frames, for example by clicking on a “Next Frame” mouse button 17, until a frame whose size best matches that of card is displayed. The user will then place his/her card on that selected frame.

Of course, the methods discussed above may be combined in order to provide the desired result. In addition, Macromedia® Flash® (www.macromedia.com) can be used as an optional application for window rendering, and different font sizes and graphical design may be applied in order to achieve the desired result when displaying a framed matrix.

Some of the applications that may be implemented using the present invention for authentication of users are:
online financial transactions, e.g., logging into a web-based banking application in order to retrieve individual account information and activities, give money transfers orders, order checks and other activities related to account management, including trading of stocks and bonds;
E-commerce transactions, including online payments and debits, e.g., Internet shopping or bill payments, and online check payments, e.g., filling and signing online check orders;
online gambling;
managing medical records, e.g., logging in to web based applications that allow users to view and manage their medical records, choose medical services, doctors etc.;
logging in to protected web sites (individual or corporate) for access to e-mail accounts or confidential or protected data, including downloading music and video;
connecting to the Internet via a dialup service through an Internet Service Provider;
online elections;
encryption of confidential information online or offline;
Hot Spots, e.g., wireless connections to the Internet from various locations (Internet cafes, airports, coffee houses, central transportation stations etc.);
any type of Browser based or non-Browser based applications that require user authentication;
software protection and registration, wherein the software installation package will contain a card according to the present invention that the user will be required to use to register the software online in order to prevent illegal copying of software;
remote access to networks such as: home office secure connection, client login to Internet sites, protected Virtual Private Networks over IPsec VPN and SSL VPN for users that are connected from home, distant geographical locations, while roaming etc., or the wireless Local Area Network (LAN) of a corporation; and
access to a local PC/computer or to a local or remote, protected network domains, in a corporate like Windows Domain Controller, local and internal Intranet web sites that provide general corporate information, documentation, supply orders, timesheets, etc.

Thus, a method and system of authentication and identification for computerized and networked systems has been provided. One skilled in the art will appreciate that the present invention can be practiced by other than the described embodiments, which are presented for purposes of illustration and not limitation.

What is claimed is:

1. A method of authenticating a user for a transaction, comprising:
providing to the user a key having a plurality of view areas, said key being uniquely associated with a predetermined code, and said plurality of view areas being arranged on said key in accordance with said predetermined code;
displaying to the user an array of characters;
accepting entry by the user of a password, said password comprising selected characters from said array, said selected characters having been revealed to the user by said plurality of view areas of said key when said key is placed over said displayed array;
correlating said entered password with said predetermined code; and
authenticating said transaction for the user if said entered password correlates to said predetermined code, and denying authentication of said transaction for the user if said entered password does not correlate to said predetermined code.

2. The method of claim 1 wherein said step of providing a key comprises providing a substantially two-dimensional body, said plurality of view areas being capable of revealing to the user said selected characters of said array when said key is placed over said displayed array.

3. The method of claim 2 wherein said body is opaque and said plurality of view areas comprise a plurality of transparent regions, such that said plurality of view areas reveal the selected characters of said array by allowing the user to view said selected characters of said array through said transparent regions when said key is placed over said displayed array.

4. The method of claim 2 wherein said plurality of view areas comprise a plurality of apertures formed through said body, such that said plurality of view areas reveal the selected characters of said array by allowing the user to view said selected characters of said array through said plurality of apertures when said key is placed over said displayed array.

5. The method of claim 2 wherein said body is transparent and said plurality of view areas comprise a plurality of areas having a distinctive indication, such that said distinctive indications reveal the selected characters of said array by allowing the user to distinguish said selected characters of said array from non-selected characters of said array when said key is placed over said displayed array.

6. The method of claim 2 wherein said step of displaying an array comprises displaying an array that is substantially of the same physical dimensions as said key, such that there is only one position in which said key may be placed over said displayed array wherein selected characters of said array are revealed to the user.

7. The method of claim 2 wherein said step of displaying an array comprises displaying an array that is of larger physical dimensions than said key, such that there are more than one position in which said key may be placed over said displayed array wherein selected characters of said array are revealed to the user.

8. The method of claim 1 wherein said step of displaying to the user an array of characters comprises displaying to the user a series of characters arranged within a two-dimensional shape.

9. The method of claim 8 wherein said step of displaying to the user a series of characters arranged within a two-dimensional shape comprises displaying to the user a series of characters arranged in a format of at least one row and at least one column oriented orthogonally with respect to each other.

10. The method of claim 8 wherein said step of displaying to the user a series of characters arranged within a two-dimensional shape comprises displaying to the user a series of characters arranged in a format of at least one row and at least one column oriented non-orthogonally with respect to each other.

11. The method of claim 8 wherein said step of displaying to the user a series of characters arranged within a two-dimensional shape comprises displaying to the user a series of characters arranged in a spiral or circular formation with at least one concentric spiral or circular row of characters.

12. The method of claim 8 wherein said step of displaying to the user a series of characters arranged within a two-dimensional shape comprises displaying to the user a series of characters arranged in a spiral or circular formation with said characters spiraling outward from a central node.

13. The method of claim 1 wherein said step of displaying to the user an array of characters comprises displaying to the user a series of characters arranged in a format determined in accordance with said unique predetermined code.

14. The method of claim 1 wherein said predetermined code comprises a plurality of vectors that indicate a plurality of specific positions in said array, and said plurality of view areas correspond to said plurality of specific positions in said array.

15. The method of claim 14 wherein each vector comprises at least one number or character that identifies a position in said array.

16. The method of claim 15 wherein said characters of said array are arranged among a plurality of positions that are sequentially identified from first position in said array to second position in said array.

17. The method of claim 14 wherein said step of displaying to the user an array of characters comprises the steps of:
creating an array of said characters in a predetermined format;
determining for said array the identities of said characters within said plurality of specific positions;
storing in a memory the identities of said characters within said plurality of specific positions;
scrambling said array such that the characters within said plurality of specific positions whose identities have been stored may or may not be in the same positions in said array as they were prior to scrambling; and
displaying to the user the scrambled array.

18. The method of claim 17 wherein said step of correlating said entered password with said predetermined code comprises the steps of:
deriving the specific positions of said selected characters in said scrambled array which have been revealed by said plurality of view areas and which have been entered by the user;
determining the identities of the characters in the unscrambled array at the same specific positions derived; and
matching the identities of the characters in the unscrambled array just determined with the identities of said characters stored in said memory.

19. The method of claim 18 wherein the identities of said characters are stored in said memory in a specific sequence, and said selected characters in said scrambled array have been entered by the user in a specific sequence,
said step of matching the identities further comprises determining whether the sequence of said characters in the unscrambled array just determined based upon the selected characters in said scrambled array entered by the user matches the sequence of said characters stored in said memory.

20. The method of claim 1 wherein said step of displaying an array or characters comprises randomly generating an array of characters prior to display of said array to the user such that said array in a first transaction has a statistically insignificant chance of being repeated in a second transaction.

21. The method of claim 20 wherein said step of accepting entry of a password comprises accepting entry by the user of a password that in a first transaction has a statistically insignificant chance of being the same password as entered in a second transaction.

22. The method of claim 21 wherein the chance of said entered password being the same in a first transaction as in a second transaction decreases as the number of character positions present in said array increases.

23. The method of claim 1 wherein said step of displaying to the user an array of characters comprises creating an array wherein said characters comprise numbers, letters, symbols or a combination of two or more thereof.

24. The method of claim 23 wherein said step of displaying to the user an array of characters comprises creating an array of said characters wherein each character appears only once in said array.

25. The method of claim 23 wherein said step of displaying to the user an array of characters comprises creating an array of said characters wherein at least one character appears more than once in said array.

26. The method of claim 1 wherein said step of accepting entry of a password comprises accepting entry by the user of selected characters from said array in a predetermined order of entry.

27. The method of claim 1 wherein said step of accepting entry of a password comprises accepting entry by the user of selected characters from said array in a specific order of entry that is indicated to the user on said key.

28. The method of claim 27 wherein said specific order of entry is indicated to the user on said key in the form of a plurality of sequential characters, each of which is provided adjacent to a specific one of said plurality of selective viewing regions.

29. The method of claim 1 wherein said step of accepting entry of a password comprises accepting entry by the user of a set of characters that are derived from arithmetic modifications of the selected characters from said array.

30. The method of claim 29 wherein said arithmetic modifications of the selected characters from said array is indicated to the user on said key in the form of a plurality of arithmetic operation indicators and a plurality of operands, one of each of which is provided adjacent to a specific one of said plurality of selective viewing regions to indicate the arithmetic operation to be taken and the operand to be used with respect to the selected character from said array that is revealed through said respective selective viewing region so as to derive a respective one of said password characters.

31. The method of claim 29 wherein said arithmetic modifications of the selected characters from said array is indicated to the user on said key in the form of a plurality of arithmetic operation indicators, one of each of which is provided adjacent to a specific one of said plurality of selective viewing regions to indicate the arithmetic operation to be taken with respect to an operand and the selected character from said array that is revealed through said respective selective viewing region so as to derive a respective one of said password characters.

32. The method of claim 31 wherein said operand is indicated to the user on said key.

33. A method of authentication of a transaction by a user, comprising:
viewing a display of an array of characters;
placing a key over said array, said key being uniquely associated with a predetermined code and having a plurality of view areas that are arranged on said key in accordance with said predetermined code;
viewing through said plurality of view areas a plurality of selected characters from said array; and
providing a password, said password comprising said plurality of selected characters from said array;
such that authentication of the transaction is permitted for the user if the entered password correlates to said predetermined code, and authentication of the transaction is denied for the user if said entered password does not correlate to said predetermined code.

34. The method of claim 33 wherein said step of placing a key comprises placing a substantially two-dimensional body over said array, said selected characters of said array being capable of being viewed through said plurality of view areas when said key is placed over said array.

35. The method of claim 34 wherein said body is opaque and said plurality of view areas comprise a plurality of transparent regions, and said step of viewing through said plurality of view areas only a plurality of selected characters from said array comprises viewing said selected characters of said array through said transparent regions when said key is placed over said displayed array.

36. The method of claim 34 wherein said plurality of view areas comprise a plurality of apertures formed through said body, and said step of viewing through said plurality of view areas only a plurality of selected characters from said array comprises viewing said selected characters of said array through said plurality of apertures when said key is placed over said displayed array.

37. The method of claim 34 wherein said body is transparent and said plurality of view areas comprise a plurality of areas having a distinctive indication, and said step of viewing through said plurality of view areas a plurality of selected characters from said array comprises using said distinctive indications to distinguish said selected characters of said array from non-selected characters of said array when said key is placed over said displayed array.

38. The method of claim 34 wherein said array is substantially of the same physical dimensions as said key, such that said step of placing a key over said array comprises placing said key in the only position in which said key may be placed over said array wherein selected characters from said array may be viewed.

39. The method of claim 34 wherein said array that is of larger physical dimensions than said key, such that said step of placing a key over said array comprises placing said key in one of at least two positions in which said key may be placed over said array wherein selected characters from said array may be viewed.

40. The method of claim 33 wherein said step of viewing a display of an array of characters comprises viewing an array wherein said characters comprise numbers, letters, symbols or a combination of two or more thereof.

41. The method of claim 40 wherein said step of viewing a display of an array of characters comprises viewing an array of said characters wherein each character appears only once in said array.

42. The method of claim 33 wherein said step of viewing a display of an array of characters comprises viewing an array of said characters wherein at least one character appears more than once in said array.

43. The method of claim 33 wherein said step of viewing a display of an array of characters comprises viewing an array comprising a series of characters arranged within a two-dimensional shape.

44. The method of claim 43 wherein said step of viewing an array comprising a series of characters arranged within a two-dimensional shape comprises viewing an array comprising a series of characters arranged in a format of at least one row and at least one column oriented orthogonally with respect to each other.

45. The method of claim 43 wherein said step of viewing an array comprising a series of characters arranged within a two-dimensional shape comprises viewing an array comprising a series of characters arranged in a format of at least one row and at least one column oriented non-non-orthogonally with respect to each other.

46. The method of claim 43 wherein said step of viewing an array comprising a series of characters arranged within a two-dimensional shape comprises viewing an array comprising a series of characters arranged in a spiral or circular formation with at least one concentric spiral or circular row of characters.

47. The method of claim 43 wherein said step of viewing an array comprising a series of characters arranged within a two-dimensional shape comprises viewing an array comprising a series of characters arranged in a spiral or circular formation with said characters spiraling outward from a central node.

48. The method of claim 33 wherein said step of viewing an array comprising a series of characters arranged within a two-dimensional shape comprises viewing an array comprising a series of characters arranged in a format determined in accordance with said unique predetermined code.

49. The method of claim 33 wherein said predetermined code comprises a plurality of vectors that indicate a plurality of specific positions in said array, and said plurality of view areas correspond to said plurality of specific positions in said array.

50. The method of claim 49 wherein each vector comprises at least one number or character that identifies a position in said array.

51. The method of claim 50 wherein said characters of said array are arranged among a plurality of positions that are sequentially identified from first position in said array to second position in said array.

52. The method of claim 49 wherein said step of viewing an array comprising a series of characters comprises viewing a scrambled array, said scrambled array having been created through the steps of:
creating an array comprising a series of said characters in a predetermined format;
determining for said array the identities of said characters within said plurality of specific positions;
storing in a memory the identities of said characters within said plurality of specific positions;
scrambling said array such that the characters within said plurality of specific positions whose identities have been stored may or may not be in the same positions in said array as they were prior to scrambling.

53. The method of claim 52 wherein said authentication of the transaction is permitted for the user through the steps of:
deriving the specific positions of said plurality of selected characters in said scrambled array which were viewed through said plurality of view areas and were provided as a password;
determining the identities of the characters in the unscrambled array at the same specific positions derived; and
matching the identities of the characters in the unscrambled array just determined with the identities of said characters stored in said memory.

54. The method of claim 52 wherein said step of storing in a memory comprises storing identities of said characters within said plurality of specific positions in a specific sequence,
said step of providing a password comprises providing said plurality of selected characters from said array in a specific sequence, and
said step of matching the identities further comprises determining whether the sequence of said characters in the unscrambled array just determined based upon the selected characters in said password provided matches the sequence of said characters stored in said memory.

55. The method of claim 33 wherein said step of providing a password comprises providing a password that in a first transaction has a significantly small chance of being the same password as entered in a second transaction.

56. The method of claim 55 wherein the chance of said password being the same in a first transaction as in a second transaction decreases as the number of character positions present in said array increases.

57. The method of claim 33 wherein said step of providing a password comprises entering said selected characters from said array in a predetermined order.

58. The method of claim 33 wherein said step of providing a password comprises entering said selected characters from said array in a specific order of entry that is indicated to the user on said key.

59. The method of claim 58 wherein said specific order of entry is indicated to the user on said key in the form of a plurality of sequential characters, each of which is provided adjacent to a specific one of said plurality of selective viewing regions.

60. The method of claim 33 wherein said step of providing a password comprises entering a set of characters that are derived from arithmetic modifications of the selected characters from said array.

61. The method of claim 60 wherein said arithmetic modifications of the selected characters from said array is indicated to the user on said key in the form of a plurality of arithmetic operation indicators and a plurality of operands, one of each of which is provided adjacent to a specific one of said plurality of selective viewing regions to indicate the arithmetic operation to be taken and the operand to be used with respect to the selected character from said array that is revealed through said respective selective viewing region so as to derive a respective one of said password characters.

62. The method of claim 60 wherein said arithmetic modifications of the selected characters from said array is indicated to the user on said key in the form of a plurality of arithmetic operation indicators, one of each of which is provided adjacent to a specific one of said plurality of selective viewing regions to indicate the arithmetic operation to be taken with respect to an operand and the selected character from said array that is revealed through said respective selective viewing region so as to derive a respective one of said password characters.

63. The method of claim 62 wherein said operand is indicated to the user on said key.
